(19) United States
(12) Patent Application Publication
(10) Pub. No.: US 2024/0179580 A1
(43) Pub. Date: May 30, 2024

(54) COMMUNICATION METHOD

(71) Applicant: KYOCERA Corporation, Kyoto (JP)

(72) Inventors: Masato FUJISHIRO, Yokohama-shi (JP); Henry CHANG, San Diego, CA (US)

(73) Assignee: KYOCERA Corporation, Kyoto (JP)

(21) Appl. No.: 18/432,719

(22) Filed: Feb. 5, 2024

Related U.S. Application Data
(63) Continuation of application No. PCT/JP2022/029767, filed on Aug. 3, 2022.
(60) Provisional application No. 63/229,619, filed on Aug. 5, 2021.

(51) Int. Cl. H04W 36/00; H04W 36/02; H04W 36/08

(52) U.S. Cl. CPC H04W 36/0007; H04W 36/023; H04W 36/08

(57) ABSTRACT

In a first aspect, a communication method is used in a mobile communication system for supporting a multicast and broadcast service (MBS). The communication method includes: configuring, by a base station managing a first cell, a multicast radio bearer (MRB) including a Point-to-Multipoint (PTM) communication path for a user equipment in a radio resource control (RRC) connected state; switching, by the base station, from the PTM communication path to a Point-to-Point (PTP) communication path in response to determining handover of the user equipment from the first cell to a second cell; and executing, by the base station, the handover after the switching to the PTP communication path.

### RELATED APPLICATIONS

The present application is a continuation based on PCT Application No. PCT/JP2022/029767, filed on Aug. 3, 2022, which claims the benefit of U.S. Provisional Patent Application No. 63/229,619 filed on Aug. 5, 2021. The content of which is incorporated by reference herein in their entirety.

### TECHNICAL FIELD

The present disclosure relates to a communication method used in a mobile communication system.

### BACKGROUND OF INVENTION

In 3rd Generation Partnership Project (3GPP) standards, technical specifications of New Radio (NR) being radio access technology of the fifth generation (5G) have been defined. NR has features such as high speed, large capacity, high reliability, and low latency, in comparison to Long Term Evolution (LTE) being radio access technology of the fourth generation (4G). In 3GPP, there have been discussions for establishing technical specifications of multicast and broadcast services (MBS) of 5G/NR (for example, see Non-Patent Document 1).

### CITATION LIST

### Non-Patent Literature

Non-Patent Document 1: 3GPP Contribution: RP-201038, “WID revision: NR Multicast and Broadcast Services”

### SUMMARY

5G/NR multicast and broadcast services are desired to provide enhanced services compared to 4G/LTE multicast and broadcast services.

In view of this, the present disclosure provides a communication method for enabling implementation of enhanced multicast and broadcast services.

In a first aspect, a communication method is used in a mobile communication system for supporting a multicast and broadcast service (MBS). The communication method includes: configuring, by a base station managing a first cell, a multicast radio bearer (MRB) including a Point-to-Multipoint (PTM) communication path for a user equipment in a radio resource control (RRC) connected state; switching, by the base station, from the PTM communication path to a Point-to-Point (PTP) communication path in response to determining handover of the user equipment from the first cell to a second cell; and executing, by the base station, the handover after the switching to the PTP communication path.

In a second aspect, a communication method is used in a mobile communication system for supporting a multicast and broadcast service (MBS). The communication method includes: receiving, by a user equipment in a radio resource control (RRC) connected state in a first cell, an MBS session provided by the first cell through Point-to-Multipoint (PTM); receiving, by the user equipment, from the first cell, single-frequency network (SFN) related information related to a SFN including the first cell and a second cell; and continuing, by the user equipment, reception of the MBS session provided by the SEN through PTM, based on the SFN-related information, even after receiving a handover command indicating handover to the second cell from the first cell.

In a third aspect, a communication method is used in a mobile communication system for supporting a multicast and broadcast service (MBS). The communication method includes: receiving, by a user equipment in a radio resource control (RRC) connected state in a first cell, an MBS session provided by the first cell through Point-to-Multipoint (PTM); and performing, by the user equipment, simultaneous reception of receiving both of the MBS session provided by the first cell and the MBS session provided by a second cell, within a predetermined time before handover to the second cell providing the MBS session through PTM and/or within a predetermined time after the handover.

In a fourth aspect, a communication method is used in a mobile communication system for supporting a multicast and broadcast service (MBS). The communication method includes: receiving, by a user equipment in a radio resource control (RRC) connected state in a first cell, an MBS session provided by the first cell through Point-to-Multipoint (PTM); receiving, by the user equipment, from the first cell, a handover command indicating handover to a second cell; and receiving, by the user equipment, the MBS session provided by the second cell after the handover. The handover command includes multicast traffic channel (MTCH) configuration information for receiving the MBS session provided by the second cell.

In a fifth aspect, a communication method is used in a mobile communication system for supporting a multicast and broadcast service (MBS). The communication method includes: receiving, by a user equipment in a radio resource control (RRC) connected state in a first cell, an MBS session provided by the first cell through Point-to-Multipoint (PTM); and receiving, by the user equipment from a second cell two MBS data streams belonging to the MBS session, after handover to the second cell providing the MBS session. The two MBS data streams have different sequence numbers at the same point in time.

In a sixth aspect, a communication method is used in a mobile communication system for supporting a multicast and broadcast service (MBS). The communication method includes: transmitting, by a first base station providing an MBS session, to a second base station, sequence number information indicating a sequence number of MBS data transmitted in the MBS session; and controlling, by the second base station, provision of the MBS session in the second base station, based on the sequence number information from the first base station.

### BRIEF DESCRIPTION OF THE DRAWINGS

FIG. 1 is a diagram illustrating a configuration of a mobile communication system according to an embodiment.

FIG. 2 is a diagram illustrating a configuration of a user equipment (UE) according to an embodiment.

FIG. 3 is a diagram illustrating a configuration of a gNB (base station) according to an embodiment.

FIG. 4 is a diagram illustrating a configuration of a protocol stack of a radio interface of a user plane handling data.

FIG. 5 is a diagram illustrating a configuration of a protocol stack of a radio interface of a control plane handling signaling (control signal).

FIG. 6 is a diagram illustrating an overview of MBS traffic delivery according to an embodiment.

FIG. 7 is a diagram illustrating delivery modes according to an embodiment.

FIG. 8 is a diagram illustrating a split multicast radio bearer (MRB) according to an embodiment.

FIG. 9 is a diagram illustrating operation of a PDCP layer in the mobile communication system according to an embodiment.

FIG. 10 is a diagram illustrating a COUNT value.

FIG. 11 is a diagram illustrating a PDCP data PDU.

FIG. 12 is a diagram illustrating operation for identifying RCVD_COUNT.

FIG. 13 is a diagram illustrating operation of a reception-side PDCP entity of the UE.

FIG. 14 is a diagram illustrating a first operation scenario of the mobile communication system according to an embodiment.

FIG. 15 is a diagram illustrating a second operation scenario of the mobile communication system according to an embodiment.

FIG. 16 is a diagram illustrating operation of the gNB according to a first embodiment.

FIG. 17 is a diagram illustrating an example of operation of the mobile communication system according to the first embodiment.

FIG. 18 is a diagram illustrating another example of operation of the mobile communication system according to the first embodiment.

FIG. 19 is a diagram illustrating operation of the UE according to a second embodiment.

FIG. 20 is a diagram illustrating an example of operation of the mobile communication system according to the second embodiment.

FIG. 21 is a diagram illustrating another example of operation of the mobile communication system according to the second embodiment.

FIG. 22 is a diagram illustrating operation of the UE according to a third embodiment.

FIG. 23 is a diagram illustrating an example of operation of the mobile communication system according to the third embodiment.

FIG. 24 is a diagram illustrating another example of operation of the mobile communication system according to the third embodiment.

FIG. 25 is a diagram illustrating operation of the UE according to a fourth embodiment.

FIG. 26 is a diagram illustrating an example of operation of the mobile communication system according to the fourth embodiment.

FIG. 27 is a diagram illustrating operation of the UE according to a fifth embodiment.

FIG. 28 is a diagram illustrating an example of operation of the mobile communication system according to the fifth embodiment.

FIG. 29 is a diagram illustrating operation of the mobile communication system according to a sixth embodiment.

FIG. 30 is a diagram illustrating switch of PDCP fixed-type PTM/PTP based on the current agreement.

### DESCRIPTION OF EMBODIMENTS

A mobile communication system according to an embodiment is described with reference to the drawings. In the description of the drawings, the same or similar parts are denoted by the same or similar reference signs.

### First Embodiment

### Configuration of Mobile Communication System

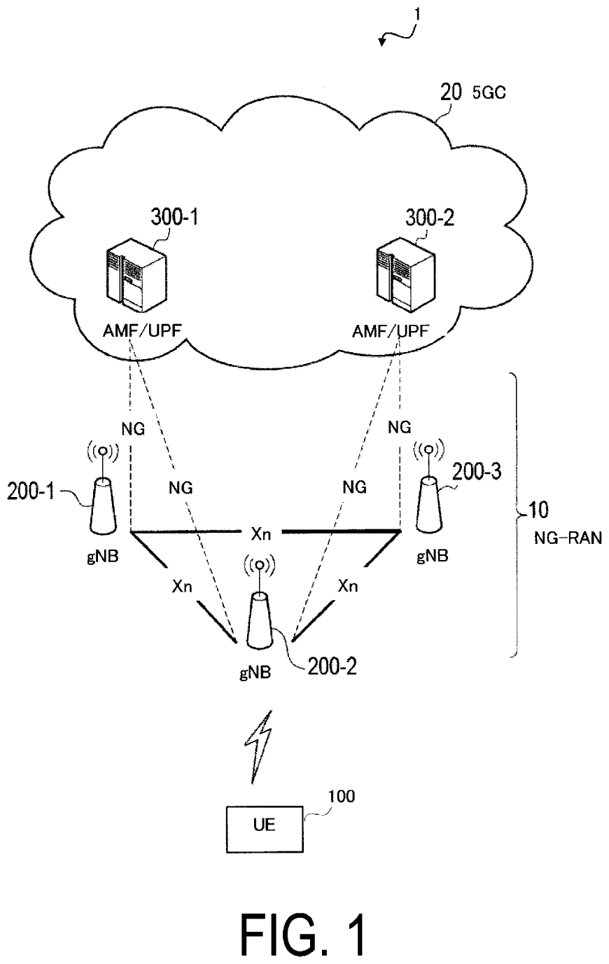

FIG. 1 is a diagram illustrating a configuration of a mobile communication system 1 according to the first embodiment. The mobile communication system 1 complies with the 5th Generation System (5GS) of the 3GPP standard. The description below takes the 5GS as an example, but Long Term Evolution (LTE) system may be at least partially applied to the mobile communication system. A sixth generation (6G) system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 may be hereinafter simply referred to as a RAN 10. The 5GC 20 may be simply referred to as a core network (CN) 20.

The UE 100 is a mobile wireless communication apparatus. The UE 100 may be any apparatus as long as the UE 100 is used by a user. Examples of the UE 100 include a mobile phone terminal (including a smartphone), a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication arca. The “cell” is also used as a term representing a function or a resource for performing wireless communication with the UE 100. One cell belongs to one carrier frequency (hereinafter simply referred to as one “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Plane Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF are connected to the gNB 200 via an NG interface which is an interface between a base station and the core network.

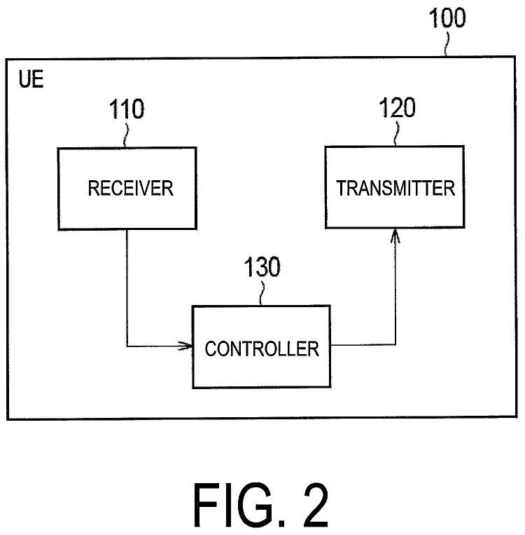

FIG. 2 is a diagram illustrating a configuration of the UE 100 (user equipment) according to the first embodiment. The UE 100 includes a receiver 110, a transmitter 120, and a controller 130. The receiver 110 and the transmitter 120 constitute a wireless communicator that performs wireless communication with the gNB 200.

The receiver 110 performs various types of reception under control of the controller 130. The receiver 110 includes an antenna and a reception device. The reception device converts a radio signal received through the antenna into a baseband signal (a reception signal) and outputs the resulting signal to the controller 130.

The transmitter 120 performs various types of transmission under control of the controller 130. The transmitter 120 includes an antenna and a transmission device. The transmission device converts a baseband signal (a transmission signal) output by the controller 130 into a radio signal and transmits the resulting signal through the antenna.

The controller 130 performs various types of control and processes in the UE 100. Such processes include processes of respective layers to be described later. The controller 130 includes at least one processor and at least one memory. The memory stores a program to be executed by the processor and information to be used for processing by the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing.

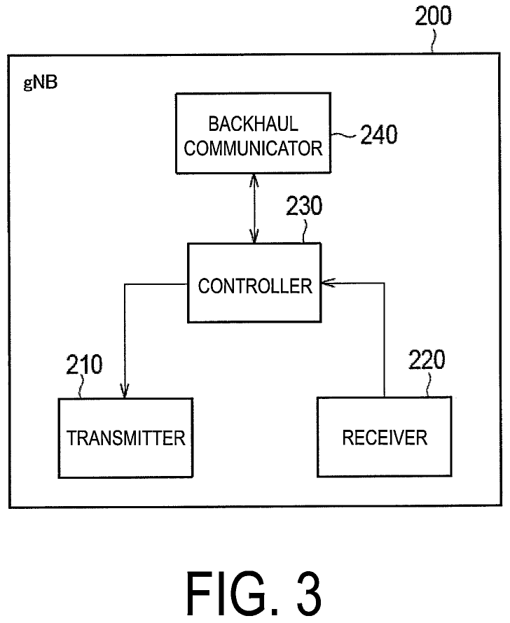

FIG. 3 is a diagram illustrating a configuration of the gNB 200 (base station) according to the first embodiment. The gNB 200 includes a transmitter 210, a receiver 220, a controller 230, and a backhaul communicator 240. The transmitter 210 and the receiver 220 constitute a wireless communicator that performs wireless communication with the UE 100. The backhaul communicator 240 constitutes a network communicator that performs communication with the CN 20.

The transmitter 210 performs various types of transmission under control of the controller 230. The transmitter 210 includes an antenna and a transmission device. The transmission device converts a baseband signal (a transmission signal) output by the controller 230 into a radio signal and transmits the resulting signal through the antenna.

The receiver 220 performs various types of reception under control of the controller 230. The receiver 220 includes an antenna and a reception device. The reception device converts a radio signal received through the antenna into a baseband signal (a reception signal) and outputs the resulting signal to the controller 230.

The controller 230 performs various types of control and processes in the gNB 200. Such processes include processes of respective layers to be described later. The controller 230 includes at least one processor and at least one memory. The memory stores a program to be executed by the processor and information to be used for processing by the processor. The processor may include a baseband processor and a CPU. The baseband processor performs modulation and demodulation, coding and decoding, and the like of a baseband signal. The CPU executes the program stored in the memory to thereby perform various types of processing.

The backhaul communicator 240 is connected to a neighboring base station via an Xn interface between base stations. The backhaul communicator 240 is connected to the AMF/UPF 300 via a NG interface between a base station and the core network. Note that the gNB 200 may include a Central Unit (CU) and a Distributed Unit (DU) (i.e., functions are divided), and the two units may be connected via an F1 interface, which is a fronthaul interface.

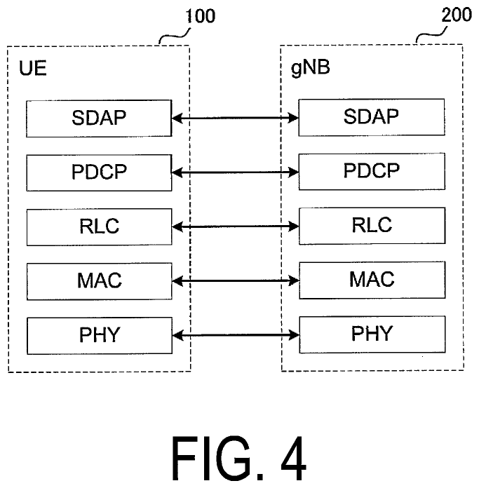

FIG. 4 is a diagram illustrating a configuration of a protocol stack of a radio interface of a user plane handling data.

A radio interface protocol of the user plane includes a physical (PHY) layer, a Medium Access Control (MAC) layer, a Radio Link Control (RLC) layer, a Packet Data Convergence Protocol (PDCP) layer, and a Service Data Adaptation Protocol (SDAP) layer.

The PHY layer performs coding and decoding, modulation and demodulation, antenna mapping and demapping, and resource mapping and demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 blind decodes the PDCCH using a radio network temporary identifier (RNTI) and acquires successfully decoded DCI as DCI addressed to the UE 100. The DCI transmitted from the gNB 200 is appended with CRC parity bits scrambled by the RNTI.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler determines transport formats (transport block sizes, Modulation and Coding Schemes (MCSs)) in the uplink and the downlink and resource blocks to be allocated to the UE 100.

The RLC layer transmits data to the RLC layer on the reception side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between an IP flow as the unit of Quality of Service (QOS) control performed by a core network and a radio bearer as the unit of QoS control performed by an Access Stratum (AS). Note that, when the RAN is connected to the EPC, the SDAP need not be provided.

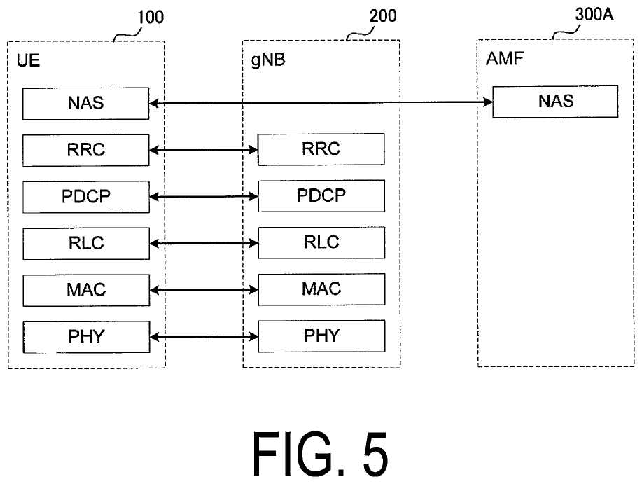

FIG. 5 is a diagram illustrating a configuration of a protocol stack of a radio interface of a control plane handling signaling (a control signal).

The protocol stack of the radio interface of the control plane includes a Radio Resource Control (RRC) layer and a Non-Access Stratum (NAS) layer instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection between the RRC of the UE 100 and the RRC of the gNB 200 (RRC connection) exists, the UE 100 is in an RRC connected state. When a connection between the RRC of the UE 100 and the RRC of the gNB 200 (RRC connection) does not exist, the UE 100 is in an RRC idle state. When the connection between the RRC of the UE 100 and the RRC of the gNB 200 is suspended, the UE 100 is in an RRC inactive state.

The NAS layer which is positioned upper than the RRC layer performs session management, mobility management, and the like. NAS signaling is transmitted between the NAS layer of the UE 100 and the NAS layer of an AMF 300. Note that the UE 100 includes an application layer other than the protocol of the radio interface. A layer lower than the NAS layer is referred to as an AS layer.

### Overview of MBS

An overview of the MBS according to the first embodiment will be described. The MBS is a service in which the NG-RAN 10 can provide broadcast or multicast, i.e., Point To Multipoint (PTM) data transmission to the UE 100. Assumed use cases (service types) of the MBS include public safety communication, mission critical communication, Vehicle to Everything (V2X) communication, IPv4 or IPv6 multicast delivery, Internet Protocol Tele Vision (IPTV), group communication, and software delivery.

A broadcast service provides a service to every UE 100 within a particular service area for an application not requiring highly reliable QoS. An MBS session used for the broadcast service is referred to as a broadcast session.

A multicast service provides a service not to every UE 100, but to a group of UEs 100 participating in the multicast service (multicast session). An MBS session used for the multicast service is referred to as a multicast session. The multicast service can provide the same content to the group of UEs 100 through a method with higher radio efficiency than the broadcast service.

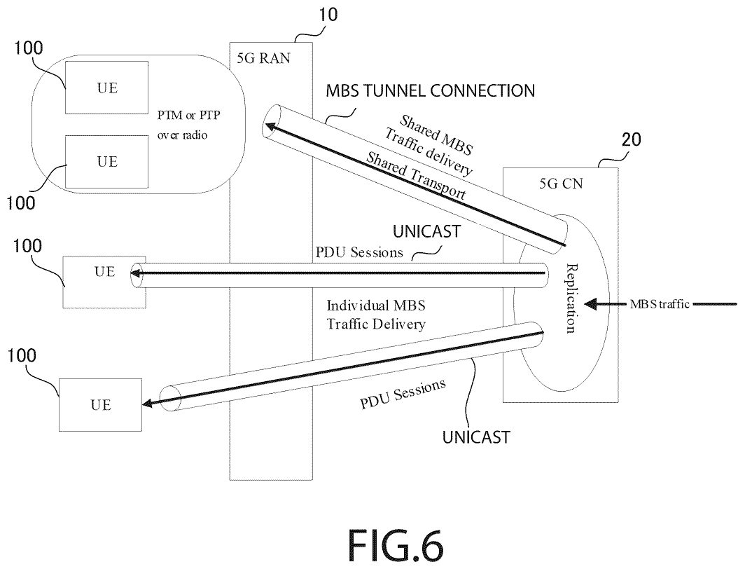

FIG. 6 is a diagram illustrating an overview of MBS traffic delivery according to the first embodiment.

MBS traffic (MBS data) is delivered from a single data source (application service provider) to a plurality of UEs. The 5G CN (5GC) 20, which is a 5G core network, receives the MBS data from the application service provider and performs Replication of the MBS data to deliver the resultant.

From the perspective of the 5GC 20, two multicast delivery methods are possible: 5GC Shared MBS Traffic delivery and 5GC Individual MBS Traffic delivery.

In the 5GC individual MBS traffic delivery method, the 5GC 20 receives a single copy of MBS data packets and delivers individual copies of these MBS data packets to the individual UEs 100 via PDU sessions of the individual UEs 100. Thus, one PDU session for each UE 100 needs to be associated with a multicast session.

In the 5GC shared MBS traffic delivery method, the 5GC 20 receives a single copy of MBS data packets and delivers the single copy of the MBS packets to a RAN node (i.e., the gNB 200). The gNB 200 receives the MBS data packets via MBS tunnel connection, and delivers those to one or more UEs 100.

From the perspective of the RAN (5G RAN) 10, two delivery methods are possible for radio transmission of the MBS data in the 5GC shared MBS traffic delivery method: a Point-to-Point (PTP) delivery method and a Point-to-Multipoint (PTM) delivery method. PTP means unicast, and PTM means multicast and broadcast.

In the PTP delivery method, the gNB 200 wirelessly delivers the individual copies of the MBS data packets to the individual UEs 100. On the other hand, in the PTM delivery method, the gNB 200 wirelessly delivers the single copy of the MBS data packets to a group of the UEs 100. The gNB 200 can dynamically determine whether to use the PTM or PTP delivery method as a method for delivering the MBS data to one UE 100.

The PTP and PTM delivery methods are mainly related to the user plane. Modes for controlling the MBS data delivery include two delivery modes: a first delivery mode and a second delivery mode.

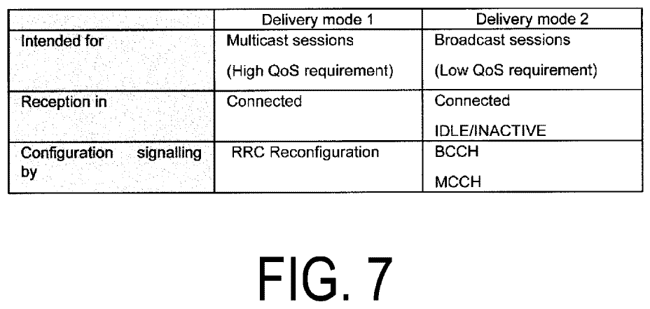

FIG. 7 is a diagram illustrating the delivery modes according to the first embodiment.

The first delivery mode (Delivery mode 1 (DM1)) is a delivery mode that can be used by the UE 100 in the RRC connected state, and is a delivery mode for high QoS requirements. The first delivery mode is used for multicast sessions among MBS sessions. Note that the first delivery mode may be used for broadcast sessions. The first delivery mode may be available to the UE 100 in the RRC idle state or the RRC inactive state.

MBS reception configuration in the first delivery mode is performed through UE-dedicated signaling. For example, the MBS reception configuration in the first delivery mode is performed through an RRC Reconfiguration message (or an RRC Release message), which is an RRC message unicast from the gNB 200 to the UE 100.

The MBS reception configuration includes MBS traffic channel configuration information (hereinafter referred to as “MTCH configuration information”) about configuration of an MBS traffic channel carrying MBS data. The MTCH configuration information includes MBS session information relating to an MBS session and scheduling information of an MBS traffic channel corresponding to the MBS session. The scheduling information of an MBS traffic channel may include discontinuous reception (DRX) configuration of the MBS traffic channel. The discontinuous reception configuration may include at least one parameter of a timer value (On Duration Timer) for defining an on-period (On Duration: reception period), a timer value (Inactivity Timer) for extending the on-period, a scheduling interval or a DRX cycle (Scheduling Period, DRX Cycle), an offset value (Start Offset, DRX Cycle Offset) of a start subframe for scheduling or a DRX cycle, a start delay slot value (Slot Offset) of an on-period timer, a timer value (Retransmission Timer) for defining a maximum time until retransmission, and a timer value (HARQ RTT Timer) for defining a minimum interval until DL assignment of HARQ retransmission.

Note that the MBS traffic channel is a type of logical channel and may be referred to as an MTCH. The MBS traffic channel is mapped to a downlink shared channel (Down Link-Shared CHannel (DL-SCH)) being a type of transport channel.

The second delivery mode (Delivery mode 2 (DM2)) is a delivery mode that can be used not only by the UE 100 in the RRC connected state, but also by the UE 100 in the RRC idle state or the RRC inactive state, and is a delivery mode for low QoS requirements. The second delivery mode is used for broadcast sessions among MBS sessions. However, the second delivery mode may also be applicable to multicast sessions.

An MBS reception configuration in the second delivery mode is performed through broadcast signaling. For example, the MBS reception configuration in the second delivery mode is performed using a logical channel transmitted from the gNB 200 to the UE 100 through broadcast, for example, a broadcast control channel (BCCH) and/or a multicast control channel (MCCH). The UE 100 can receive the BCCH and the MCCH, using a dedicated RNTI defined in technical specifications in advance, for example. The RNTI for BCCH reception may be an SI-RNTI, and the RNTI for MCCH reception may be an MCCH-RNTI.

In the second delivery mode, the UE 100 may receive the MBS data in the following three procedures. Firstly, the UE 100 receives MCCH configuration information on an SIB (MBS-SIB) transmitted from the gNB 200 on the BCCH. Secondly, the UE 100 receives the MCCH from the gNB 200, based on the MCCH configuration information. On the MCCH, MTCH configuration information is transmitted. Thirdly, the UE 100 receives the MTCH (MBS data), based on the MTCH configuration information. The MTCH configuration information and/or the MCCH configuration information may be hereinafter referred to as the MBS reception configuration.

In the first delivery mode and the second delivery mode, the UE 100 may receive the MTCH, using a group RNTI (G-RNTI) assigned from the gNB 200. The G-RNTI corresponds to an RNTI for MTCH reception. The G-RNTI may be included in the MBS reception configuration (MTCH configuration information).

The network can provide different MBS services for different MBS sessions. The MBS session is identified by at least one selected from the group consisting of a Temporary Mobile Group Identity (TMGI), a source-specific IP multicast address (which consists of a source unicast IP address, such as an application function and an application server, and an IP multicast address indicating a destination address), a session identifier, and a G-RNTI. At least one selected from the group consisting of the TMGI, the G-RNTI, the source-specific IP multicast address, and the session identifier is referred to as an MBS session identifier. The TMGI, the source-specific IP multicast address, the session identifier, and the G-RNTI are collectively referred to as MBS session information.

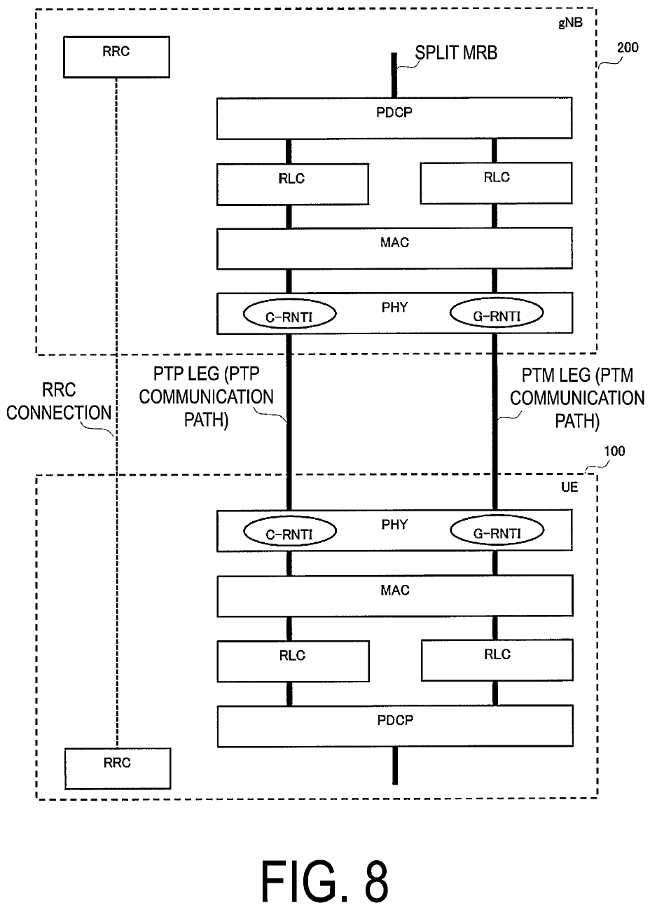

FIG. 8 is a diagram illustrating a split multicast radio bearer (MRB) according to the first embodiment. The MRB may be a type of data radio bearer (DRB). The split MRB may be used in the first delivery mode described above.

The gNB 200 may configure the MRB split into a PTP communication path and a PTM communication path for the UE 100. This allows the gNB 200 to dynamically switch the transmission of the MBS data to the UE 100 between the PTP (PTP communication path) and the PTM (PTM communication path). The gNB 200 may perform duplication transmission of the same MBS data using both the PTP (PTP communication path) and the PTM (PTM communication path) to enhance reliability. Hereinafter, the PTP communication path is referred to as a PTP leg, and the PTM communication path is referred to as a PTM leg. A functional unit corresponding to each layer is referred to as an entity.

A predetermined layer terminating the split is the MAC layer (HARQ), the RLC layer, the PDCP layer, or the SDAP layer. Although an example in which the predetermined layer terminating the split is the PDCP layer will be mainly described below, the predetermined layer may be the MAC layer (HARQ), the RLC layer, or the SDAP layer.

Each of the PDCP entity of the gNB 200 and the PDCP entity of the UE 100 splits the MRB, which is a bearer (data radio bearer) used for the MBS, into a PTP leg and a PTM leg. Note that the PDCP entity is provided for each bearer.

Each of the gNB 200 and the UE 100 includes two RLC entities provided for the respective legs, one MAC entity, and one PHY entity. The PHY entity may be provided per leg. Note that, in a Dual Connectivity in which the UE 100 communicates with two gNBs 200, the UE 100 may include two MAC entities.

The PHY entity transmits and receives data of the PTP leg using a cell RNTI (Cell Radio Network Temporary Identifier (C-RNTI)) that is allocated to the UE 100 on a one-to-one basis. The PHY entity transmits and receives data of the PTM leg, using the G-RNTI assigned to the MBS session on a one-to-one basis. The C-RNTI is different for each UE 100, but the G-RNTI is an RNTI common to a plurality of UEs 100 receiving one MBS session.

In order to perform PTM transmission of the MBS data (multicast or broadcast) from the gNB 200 to the UE 100 using a PTM leg, a split MRB needs to be configured for the UE 100 from the gNB 200 and the PTM leg needs to be activated (activation). In other words, even if a split MRB is configured for the UE 100, when a PTM leg is in a deactivation state, the gNB 200 cannot perform the PTM transmission of the MBS data using the PTM leg.

In order that the gNB 200 and the UE 100 perform PTP transmission of the MBS data (unicast) using a PTP leg, a split MRB needs to be configured for the UE 100 from the gNB 200 and the PTP leg needs to be activated. In other words, even if a split MRB is configured for the UE 100, when a PTP leg is in a deactivation state, the gNB 200 cannot perform the PTP transmission of the MBS data using the PTP leg.

When the PTM leg is in an activated state, the UE 100 monitors a PDCCH to which a G-RNTI associated with the MBS session is applied (i.e., performs blind decoding of the PDCCH, using the G-RNTI). The UE 100 may monitor the PDCCH only at a scheduling occasion of the MBS session.

When the PTM leg is in a deactivated state, the UE 100 does not monitor a PDCCH to which a G-RNTI associated with the MBS session is applied (i.e., does not perform blind decoding of the PDCCH using the G-RNTI).

When the PTP leg is in an activated state, the UE 100 monitors a PDCCH to which a C-RNTI is applied. When Discontinuous Reception (DRX) in the PTP leg is configured, the UE 100 monitors a PDCCH for a configured OnDuration period. When a cell (frequency) associated with the MBS session is specified, the UE 100 may monitor a PDCCH for the cell even when the cell is deactivated.

When the PTP leg is in a deactivated state, the UE 100 may monitor a PDCCH to which a C-RNTI is applied in preparation for normal unicast downlink transmission of other than the MBS data. Note that, when a cell (frequency) associated with an MBS session is specified, the UE 100 need not monitor a PDCCH for the MBS session.

Note that the above-described split MRB is assumed to be configured by an RRC message (for example, an RRC Reconfiguration message) transmitted by the RRC entity of the gNB 200 to the RRC entity of the UE 100.

### Operation of PDCP Layer

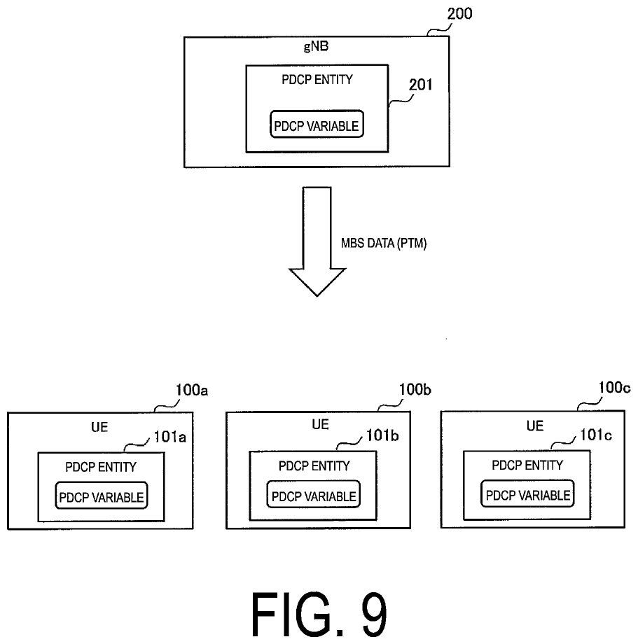

FIG. 9 is a diagram illustrating operation of the PDCP layer in the mobile communication system 1 according to the first embodiment.

The gNB 200 transmits MBS data of a certain MBS session to a plurality of UEs 100 (in the example of FIG. 9, a UE 100a to a UE 100c) through PTM (multicast or broadcast). The RRC state of each UE 100 may be any state (the RRC connected state, the RRC idle state, or the RRC inactive state). The MBS delivery mode may be the first delivery mode or the second delivery mode. The MBS delivery in the first delivery mode may use the PTM leg.

In the PDCP layer, the gNB 200 includes a PDCP entity 201 associated with the MBS session (specifically, a transmission-side PDCP entity associated with a multicast radio bearer (MRB) belonging to the MBS session). When the PDCP entity 201 starts transmission of the MBS session, the PDCP entity 201 manages a PDCP variable updated in response to transmission of a PDCP packet in the MBS session.

In the PDCP layer, each UE 100 includes a PDCP entity 101 associated with the MBS session (specifically, a reception-side PDCP entity associated with an MRB belonging to the MBS session). When each PDCP entity 101 (in the example of FIG. 9, a PDCP entity 101a to a PDCP entity 101b) starts transmission of the MBS session, the PDCP entity 101 manages a PDCP variable updated in response to reception of a PDCP packet in the MBS session.

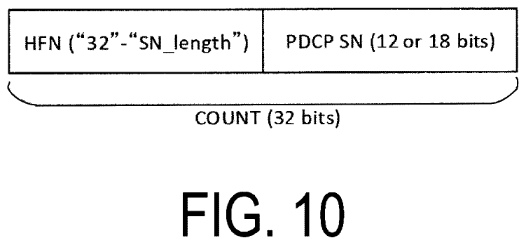

As illustrated in FIG. 10, the PDCP variable may be a count value (COUNT value) consisting of a hyper frame number (HFN) that is counted up every time a PDCP sequence number makes one round and a PDCP sequence number (PDCP SN). For example, the COUNT value has a bit length of 32 bits, the PDCP SN has a bit length (SN_length) of 12 bits or 18 bits, and the HFN has a bit length obtained by subtracting the bit length of the PDCP SN from the bit length of the COUNT value. The bit length of the PDCP SN may be configured using RRC signaling. Note that the term “PDCP variable” need not necessarily indicate the COUNT value, and may also be used as a term indicating various variables (the HFN, the PDCP SN, or the like) handled in the PDCP layer.

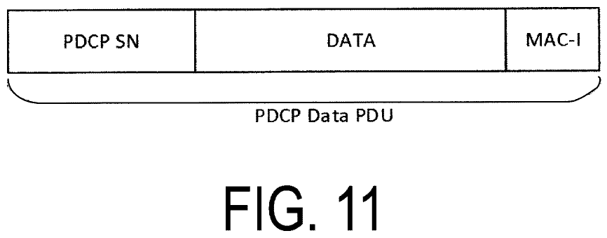

FIG. 11 is a diagram illustrating a PDCP packet, specifically, a PDCP data Protocol Data Unit (PDU), constituting MBS data. As illustrated in FIG. 11, the PDCP data PDU includes a PDCP SN, data, and a MAC-I. The PDCP SN is a sequence number sequentially assigned to the PDCP data PDU. The data corresponds to a PDCP Service Data Unit (SDU).

The MAC-I corresponds to a message authentication code. The PDCP data PDU may not include the MAC-I. As described above, the PDCP data PDU includes the PDCP SN but does not include the HFN. Thus, each of the gNB 200 and the UE 100 needs to update the HFN in response to transmission and reception of the PDCP data PDU, specifically, count up the HFN every time the PDCP sequence number makes one round.

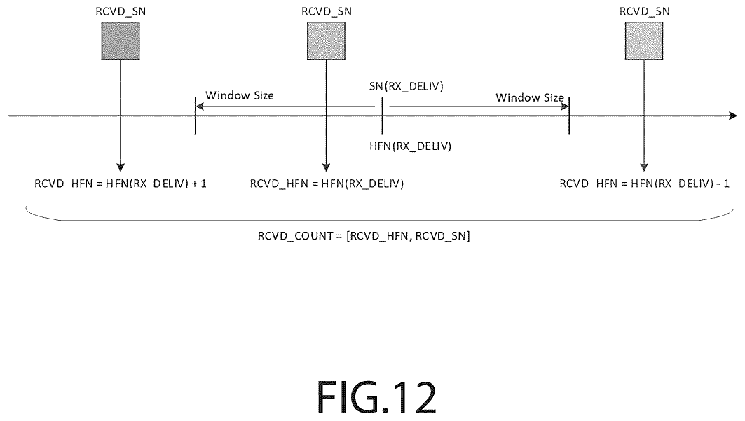

FIG. 12 is a diagram illustrating operation for identifying RCVD_COUNT being a COUNT value of the PDCP data PDU received in the UE 100 (reception-side PDCP entity 101). Here, the PDCP SN included in the received PDCP data PDU is referred to as RCVD_SN.

Firstly, when RCVD_SN<SN (RX_DELIV)−Window_Size, RCVD_HFN=HFN(RX_DELIV)+1. Here, RX_DELIV is a variable indicating the oldest PDCP SDU that is to be received and that has not yet been provided to a higher layer. The initial value of RX_DELIV is zero. Window_Size is a constant indicating the size of a reordering window.

Secondly, when RCVD_SN>SN (RX_DELIV)+Window_Size, RCVD_HFN=HFN(RX_DELIV)−1.

Thirdly, when none of the above conditions are satisfied, RCVD_HFN=HFN(RX_DELIV).

Then, RCVD_COUNT=[RCVD_HFN, RCVD_SN] is set.

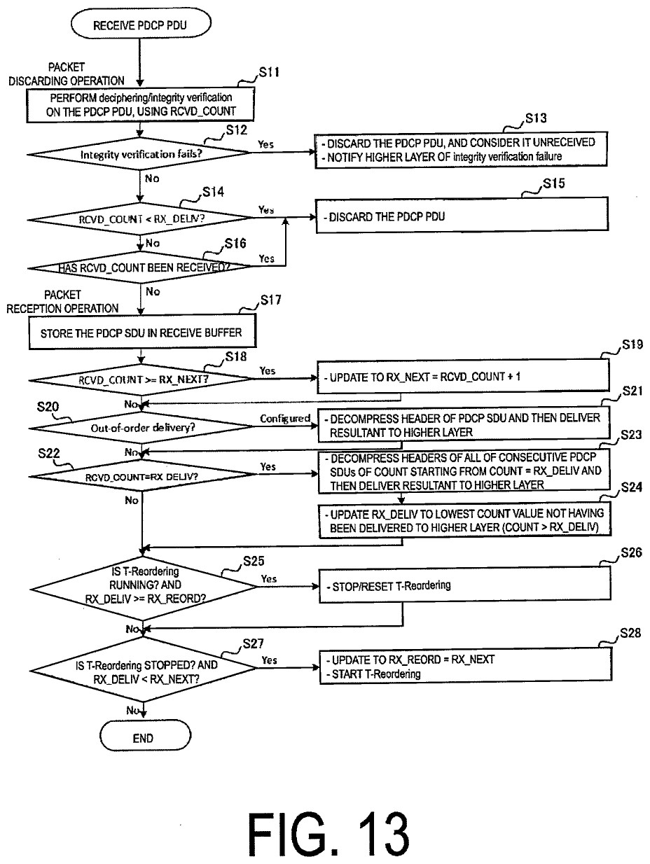

FIG. 13 is a diagram illustrating operation of the reception-side PDCP entity 101 of the UE 100.

First, when the reception-side PDCP entity 101 receives the PDCP PDU, the reception-side PDCP entity 101 performs security processing (specifically, deciphering/integrity verification) using the count value (RCVD_COUNT) on the PDCP PDU (Step S11), and when the reception-side PDCP entity 101 fails in the integrity verification (Step S12: Yes), the reception-side PDCP entity 101 notifies a higher layer of the integrity verification failure and discards the PDCP PDU (Step S13).

When the reception-side PDCP entity 101 succeeds in the integrity verification (Step S12: No), and the count value (RCVD_COUNT) is smaller than RX_DELIV (Step S14: Yes) or RCVD_COUNT has been received (Step S16: Yes), the reception-side PDCP entity 101 discards the PDCP PDU (Step S15).

Next, the reception-side PDCP entity 101 stores the undiscarded PDCP PDU in a receive buffer (Step S17), and when “RCVD_COUNT >RX_NEXT” (Step S18: Yes), the reception-side PDCP entity 101 updates to RX_NEXT=RCVD_COUNT+1 (Step S19). Here, RX_NEXT is a variable indicating a count value (RCVD_COUNT) of the PDCP SDU expected to be received next. The initial value of RX_NEXT is zero. When Out-of-order delivery is configured (Step S20: Configured), the reception-side PDCP entity 101 decompresses a header of the PDCP PDU and then delivers the resultant to a higher layer (Step S21). Specifically, when “outOfOrderDelivery” is configured in RRC, the reception-side PDCP entity 101 performs operation of S21. Out of order delivery is an operation of delivering packets to a higher layer without performing order control. Thus, as in Step S21, immediately after a packet is received and is stored in a buffer, the packet is delivered to a higher layer. Note that, when Step S20 is “No”, order control is performed.

When “RCVD_COUNT=RX_DELIV” (Step S22: Yes), the reception-side PDCP entity 101 decompresses headers of all of the consecutive PDCP SDUs of COUNT starting from COUNT=RX_DELIV and then delivers the resultant to a higher layer (Step S23), and updates RX_DELIV to a first (lowest) COUNT value that has not been delivered to a higher layer (Step S24).

When T-Reordering is running and “RX_DELIV >RX_REORD” (Step S25: Yes), the reception-side PDCP entity 101 stops and resets T-Reordering (Step S26). Here, T-Reordering is a timer used for detecting loss of the PDCP data PDU. RX_REORD is a variable indicating a COUNT value that follows the COUNT value associated with the PDCP data PDU for triggering T-Reordering.

When T-Reordering is stopped and “RX_DELIV <RX_REORD” (Step S27: Yes), the reception-side PDCP entity 101 updates RX_REORD=RX_NEXT and starts T-Reordering.

### Operation of Mobile Communication System

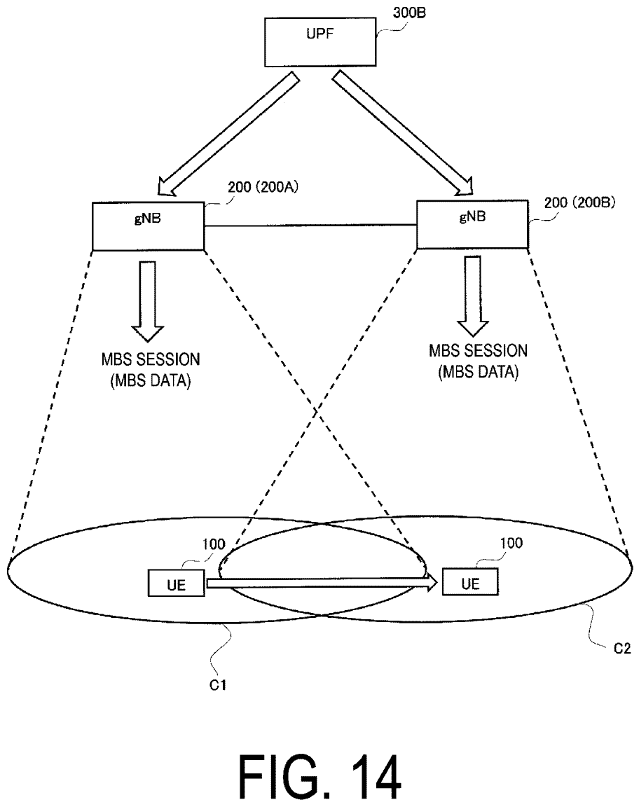

FIG. 14 is a diagram illustrating a first operation scenario of the mobile communication system 1 according to the first embodiment.

A gNB 200A manages a cell C1 (first cell), and a gNB 200B in a neighboring relationship with the gNB 200A manages a cell C2 (second cell). Coverages of the cell C1 and the cell C2 at least partially overlap. The gNB 200A and the gNB 200B are connected to each other via an Xn interface being an interface between base stations. In the following, inter-base station communication between the gNB 200A and the gNB 200B is performed on the Xn interface.

The gNB 200A provides an MBS session in the cell C1. Specifically, the gNB 200A receives MBS data belonging to the MBS session from a UPF 300B, and transmits the MBS data in the cell C1 through PTM (multicast/broadcast). The UE 100 in the RRC connected state performs reception (MBS reception) of the MBS data transmitted in the cell C1 through PTM. In the following, reception of the MBS data (MBS reception) transmitted through PTM is also referred to as PTM reception.

The gNB 200B provides an MBS session in the cell C2. Specifically, the gNB 200B receives MBS data belonging to the MBS session from a UPF 300B, and transmits the MBS data in the cell C2 through PTM. In the cell C2, the gNB 200B may provide the same MBS session as the MBS session provided in the cell C1.

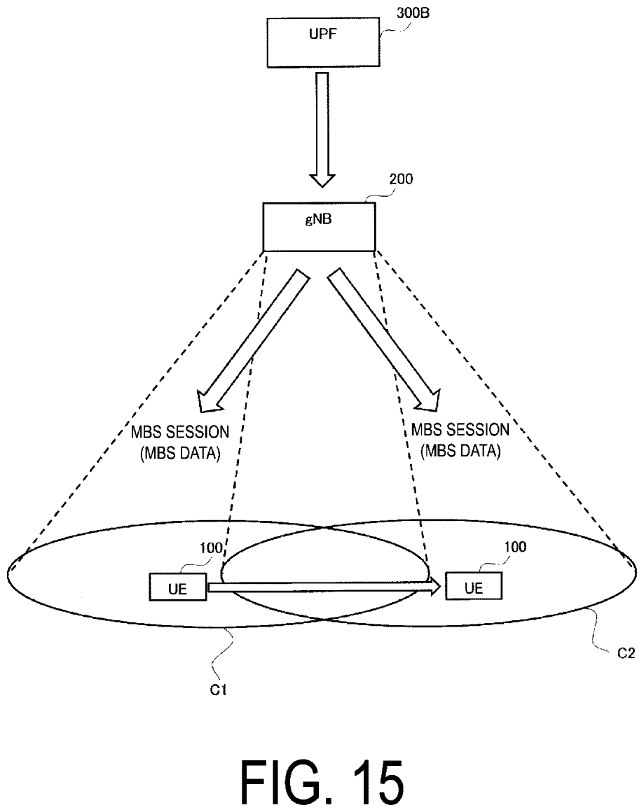

FIG. 15 is a diagram illustrating a second operation scenario of the mobile communication system 1 according to the first embodiment.

The second operation scenario is different from the first operation scenario in that the cell C1 (first cell) and the cell C2 (second cell) are managed by one gNB 200. The gNB 200 provides an MBS session in each of the cell C1 and the cell C2. Specifically, the gNB 200 transmits the MBS data in each of the cell C1 and the cell C2 through PTM (multicast/broadcast).

In the first operation scenario and the second operation scenario, the UE 100 in the RRC connected state moves from the cell C1 toward the cell C2. The gNB 200 (gNB 200A) determines handover of the UE 100 to the cell C2, based on a measurement report from the UE 100, for example, and transmits a handover command to the UE 100. In response to reception of the handover command, the UE 100 accesses the cell C2 (gNB 200B).

Here, although the UE 100 performs PTM reception in the cell C1, it is difficult to perform PTM reception from the cell C1 or the cell C2 from when the UE 100 receives the handover command from the cell C1 to when the UE 100 completes accessing the cell C2 (specifically, the random access procedure). Thus, PTM reception of the UE 100 may be interrupted during execution of the handover, and a loss may occur in the MBS data received by the UE 100.

Handover in which a loss of the MBS data due to handover less likely occurs (hereinafter referred to as “lossless handover”) will be described below. Note that, under the assumption that handover of the UE 100 from the cell C1 to the cell C2 is performed, the cell C1 is referred to as a source cell C1, and the cell C2 is referred to as a target cell C2.

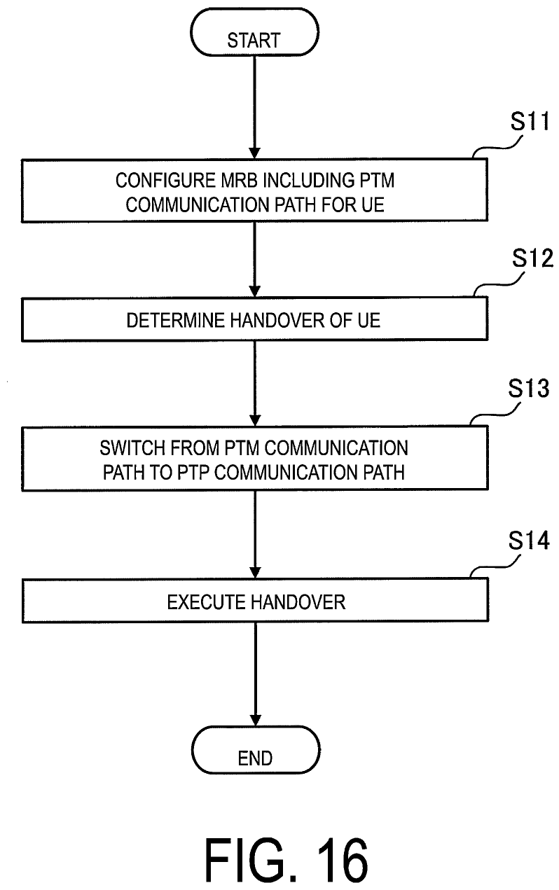

FIG. 16 is a diagram illustrating operation of the gNB 200 according to the first embodiment. The gNB 200 may be a base station that manages the source cell C1, and may be the gNB 200A illustrated in FIG. 14 or the gNB 200 illustrated in FIG. 15.

In Step S11, the gNB 200 configures the MRB including the PTM communication path to be used for PTM transmission and reception for the UE 100 in the RRC connected state in the source cell C1.

In Step S12, the gNB 200 determines handover of the UE 100 from the source cell C1 to the target cell C2.

In Step S13, the gNB 200 performs, for the UE 100, switch from the PTM communication path to the PTP communication path used for PTP transmission and reception.

In Step S14, the gNB 200 executes handover of the UE 100 to the target cell C2.

As described above, in the first embodiment, the gNB 200 that has determined handover of the UE 100 to the target cell C2 executes handover after performing switch from the PTM communication path to the PTP communication path. That is, the gNB 200 switches transmission of the MBS data for the UE 100 from PTM transmission (multicast/broadcast) to PTP transmission (unicast) and then executes handover, and can thereby implement the lossless handover.

In Step S11, the gNB 200 may configure the split MRB including the PTP leg being a PTP communication path and the PTM leg being a PTM communication path for the UE 100. In Step S13, the gNB 200 may deactivate the PTM leg while having the PTP leg in an activated state. Alternatively, in Step S13, the gNB 200 may reconfigure the split MRB to a PTP-only MRB being a PTP communication path.

Alternatively, in Step S11, the gNB 200 may configure a PTM-only MRB being a PTM communication path for the UE 100. In Step S13, the gNB 200 may reconfigure the PTM-only MRB to the PTP-only MRB being a PTP communication path.

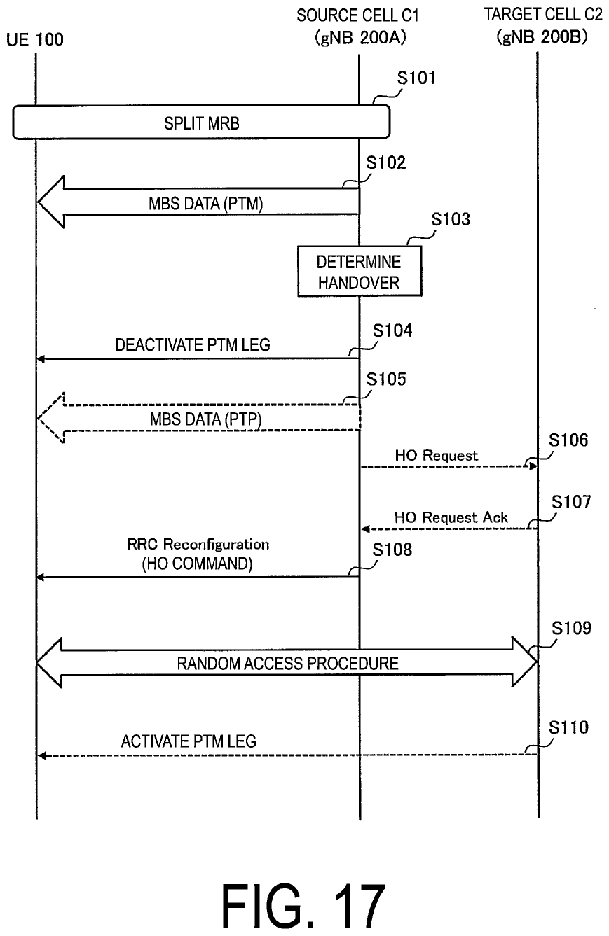

FIG. 17 is a diagram illustrating an example of operation of the mobile communication system 1 according to the first embodiment. In each of the following operation examples, the first operation scenario (see FIG. 14) is mainly assumed, but the second operation scenario (sec FIG. 15) may be assumed. That is, the gNB 200A and the gNB 200B may be the same gNB 200.

In Step S101, the gNB 200A transmits configuration information for configuring the split MRB for the UE 100 to the UE 100, using UE-dedicated RRC signaling (for example, an RRC Reconfiguration message). The UE 100 receives the configuration information of the split MRB from the gNB 200A (source cell C1), and establishes the split MRB (and a corresponding PDCP entity 101).

In Step S102, the gNB 200A starts PTM transmission of the MBS data, using the PTM leg. The UE 100 receives the MBS data on the PTM leg.

In Step S103, the gNB 200A determines handover of the UE 100, based on a measurement report from the UE 100, for example.

In Step S104, the gNB 200A deactivates the PTM leg. For example, the gNB 200A transmits a MAC control element (CE) or DCI for deactivating the PTM leg to the UE 100, and thereby deactivates the PTM leg. Note that, even when the PTM leg is deactivated, the PTP leg remains activated. Thus, for example, a reception error packet of the PTM leg can be retransmitted and complemented owing to recovery of the PDCP layer, using the PTP leg (Step S105).

In Step S106, the gNB 200A transmits a handover request (HO Request) message for requesting handover of the UE 100 to the gNB 200B.

In Step S107, in response to reception of the handover request (HO Request) message, the gNB 200B transmits a handover request acknowledge (HO Request Ack) message for acknowledging the handover of the UE 100 to the gNB 200A. The handover request acknowledge (HO Request Ack) message includes a handover command (RRC container) to be transmitted to the UE 100 via the gNB 200A. Note that the operation from Step S103 to Step S107 is included in a Handover Preparation phase.

In Step S108, in response to reception of the handover request acknowledge (HO Request Ack) message, the gNB 200A transmits the handover command (RRC Reconfiguration message with sync) to the UE 100.

In Step S107, the gNB 200B may include the configuration information for configuring the split MRB in the handover command (handover request acknowledge message). In Step S108, when the UE 100 is configured with the split MRB in response to the configuration information included in the handover command, the PTM leg may be configured in a deactivated state.

In Step S109, in response to reception of the handover command from the source cell C1 (gNB 200A), the UE 100 accesses the target cell C2 (gNB 200B), specifically, performs the random access procedure. Here, the UE 100 transmits an RRC Reconfiguration Complete message to the target cell C2 (gNB 200B). Note that a Handover Execution phase includes the operation of Steps S108 and S109.

In Step S110, the gNB 200B may activate the PTM leg of the split MRB after execution of the handover. For example, the gNB 200B transmits a MAC CE or DCI for activating the PTM leg to the UE 100, and thereby activates the PTM leg.

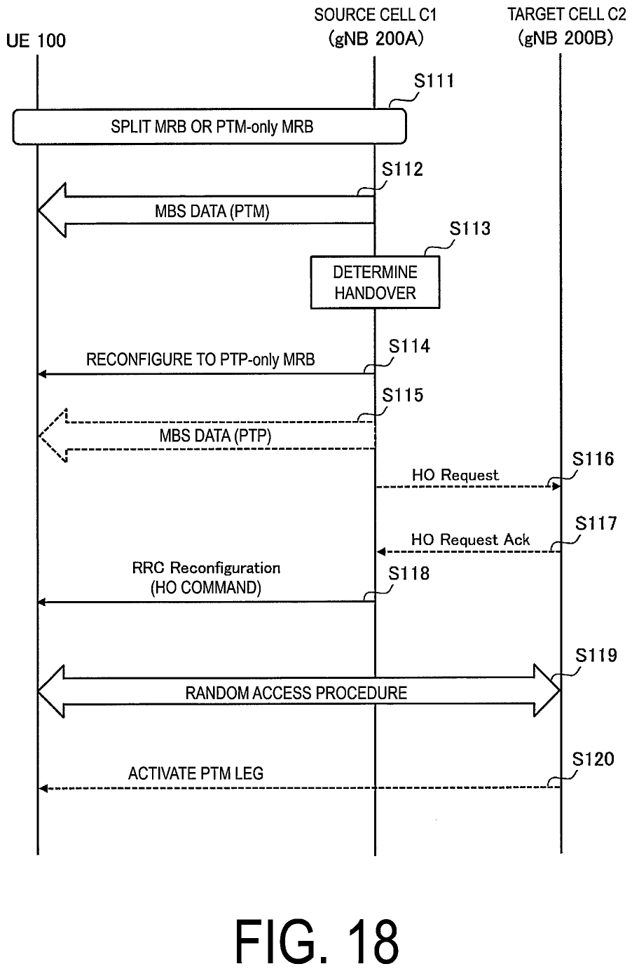

FIG. 18 is a diagram illustrating another example of operation of the mobile communication system 1 according to the first embodiment. Here, differences from the operation example illustrated in FIG. 17 will be mainly described.

In Step S111, the gNB 200A transmits the configuration information for configuring the split MRB or the PTM-only MRB for the UE 100 to the UE 100, using UE-dedicated RRC signaling (for example, an RRC Reconfiguration message). The UE 100 receives the configuration information from the gNB 200A (source cell C1), and establishes the split MRB or the PTM-only MRB.

In Step S112, the gNB 200A starts PTM transmission of the MBS data, using the PTM leg or the PTM-only MRB. The UE 100 receives the MBS data on the PTM leg or the PTM-only MRB.

In Step S113, the gNB 200A determines handover of the UE 100, based on a measurement report from the UE 100, for example.

In Step S114, the gNB 200A reconfigures the PTM leg or the PTM-only MRB configured for the UE 100 to the PTP-only MRB. For example, the gNB 200A transmits, to the UE 100, an RRC Reconfiguration message for reconfiguring the PTM leg or the PTM-only MRB configured for the UE 100 to the PTP-only MRB. After reconfiguring to the PTP-only MRB, the gNB 200A may transmit the MBS data to the UE 100, using the PTP-only MRB (Step S115).

The operation from Step S116 to Step S120 is the same as and/or similar to that in the operation example illustrated in FIG. 17.

### Second Embodiment

A second embodiment will be described mainly regarding differences from the first embodiment described above.

In the second embodiment, a plurality of cells including the source cell C1 and the target cell C2 may include a single-frequency network (SFN) regarding a certain MBS session. The cells configuring the SFN simultaneously transmit the same MBS transmission signal on the same frequency. By performing the handover of the UE 100 in such an SFN, the lossless handover can be performed while maintaining PTM.

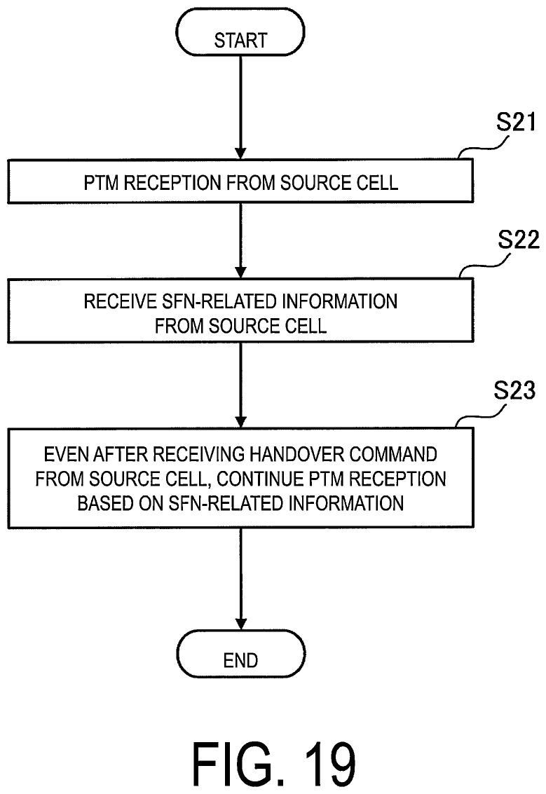

FIG. 19 is a diagram illustrating operation of the UE 100 according to the second embodiment.

In Step S21, the UE 100 in the RRC connected state in the source cell C1 receives an MBS session provided by the source cell C1 through PTM.

In Step S22, the UE 100 receives, from the source cell C1, SFN-related information related to the SFN including the source cell C1 and the target cell C2.

In Step S23, even after the UE 100 receives a handover command for indicating

handover to the target cell C2 from the source cell C1, the UE 100 continues reception of the MBS session provided by the SFN through PTM, based on the SFN-related information.

In Step S22, the UE 100 may receive the handover command including the SFN-related information. The SFN-related information may include an identifier related to the MBS session provided by the SFN and/or information indicating that the MRB associated with the MBS session is maintained.

In Step S22, the UE 100 may receive the SFN-related information from the source cell C1 before receiving the handover command. The SFN-related information may include an identifier related to the MBS session provided by the SFN and/or information indicating each cell and/or frequency constituting the SFN.

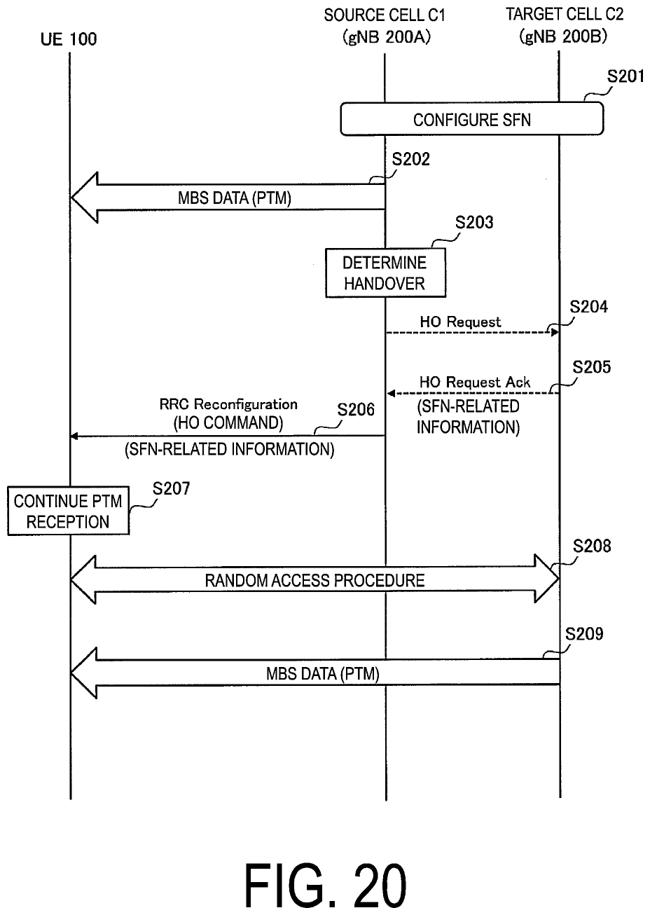

FIG. 20 is a diagram illustrating an example of operation of the mobile communication system 1 according to the second embodiment.

In Step S201, the source cell C1 and the target cell C2 constitute the SFN for a certain MBS session. Each gNB 200 recognizes which neighboring gNB (neighboring cell) configures the SFN with the gNB 200.

In Step S202, the gNB 200A provides the MBS session to the UE 100. Specifically, the gNB 200A performs PTM transmission of the MBS data. Note that the gNB 200A recognizes that the UE 100 is currently receiving the MBS session.

In Step S203, the gNB 200A determines to perform handover of the UE 100.

In Step S204, the gNB 200A transmits a handover request message to the gNB 200B. The message includes, as a UE context, information of the MBS session being currently received by the UE 100.

The gNB 200B that has received the handover request message determines to accept the handover. The gNB 200B recognizes that the MBS session being currently received by the UE 100 configures the SFN with the source cell C1.

In Step S205, the gNB 200B transmits a handover request acknowledge message to the gNB 200A. The message includes an RRC Reconfiguration message (handover command) to be transmitted to be UE 100 via the gNB 200A. The RRC Reconfiguration message includes the SFN-related information (SFN-related configuration).

For example, the RRC Reconfiguration message may include an MBS session identifier of the MBS session with which the SFN is configured and/or a bearer/channel identifier (for example, a bearer ID, a QoS flow ID, an RLC channel ID, and/or a logical channel (LC) ID) associated with the MBS session. The RRC Reconfiguration message may include an MBS session identifier of the MBS session with which a user plane protocol stack, such as the PDCP entity and the RLC entity, need not be reestablished/reset (i.e., is continuously used) and/or a bearer/channel identifier (for example, a bearer ID, a QoS flow ID, an RLC channel ID, and/or an LCID) with which the user plane protocol stack need not be reestablished/reset (i.e., is continuously used).

In Step S206, the gNB 200A transmits the RRC Reconfiguration message to the UE 100 (handover command).

In Step S207, the UE 100 that has received the RRC Reconfiguration message continues PTM reception operation of the MRB associated with the MBS session provided by the SFN, based on the SFN-related information included in the RRC Reconfiguration message. Specifically, the UE 100 continues PTM reception operation even during reconfiguration of another bearer, without performing processing such as reestablishment/reconfiguration of the PDCP entity, the RLC entity, and the like. Such another bearer refers to, for example, a unicast bearer or a multicast/broadcast bearer with which the SFN is not configured. As described above, when handover is performed based on the SFN, the UE 100 maintains the user plane related to the MBS as it is, and transfers the rest of the user plane (a unicast bearer and the like) and the control plane to the target cell C2. Here, the UE 100 can perform control such that the MRB is not released due to handover.

In Step S208, the UE 100 performs the random access procedure with the target cell C2 (gNB 200B).

In Step S209, the UE 100 performs PTM reception from the target cell C2 (gNB 200B).

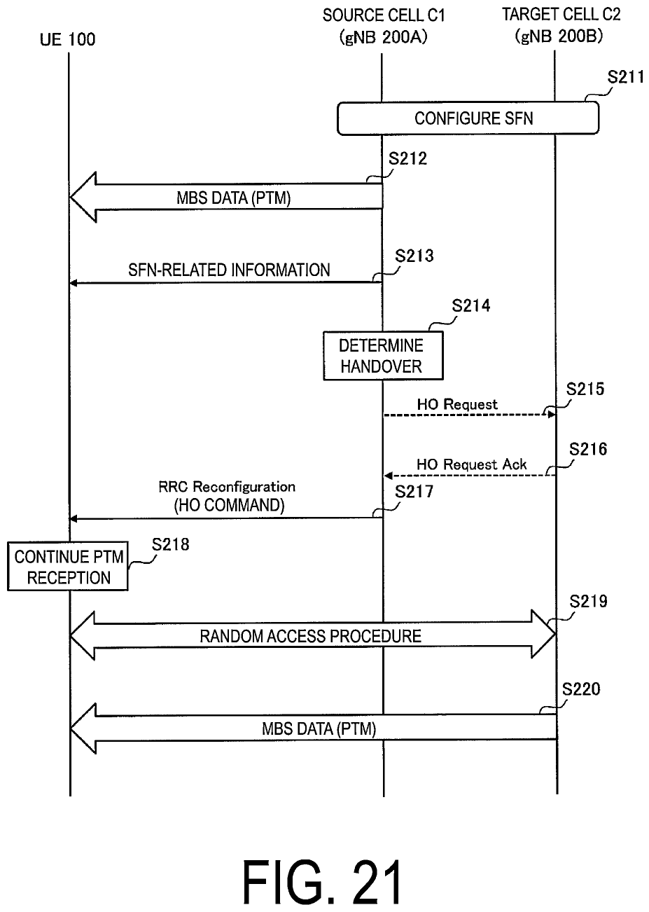

FIG. 21 is a diagram illustrating another example of operation of the mobile communication system 1 according to the second embodiment. In the present operation example, the source cell C1 (gNB 200A) provides the SFN-related information to the UE 100 in advance, before transmitting the handover command.

In Step S211, the source cell C1 configures the SFN with the target cell C2 regarding a certain MBS session.

In Step S212, the gNB 200A provides the MBS session to the UE 100. Specifically, the gNB 200A performs PTM transmission of the MBS data.

In Step S213, the gNB 200A (source cell C1) transmits the SFN-related information (SFN-related configuration) to the UE 100. The gNB 200A may transmit the SFN-related information, using UE-dedicated signaling (for example, an RRC Reconfiguration message) or broadcast signaling (for example, an SIB or an MCCH).

Here, the SFN-related information may include information indicating whether the SFN is configured for each MBS session identifier. When the SFN is configured, the SFN-related information may include a list of cells (cell IDs) configuring the SFN. Note that, when cells uniformly configure the SFN in a certain frequency, the SFN-related information may include an identifier of the frequency, instead of the list. Instead of the MBS session identifier, a QoS flow ID, a bearer ID, an RLC channel ID and/or an LCID may be used. The UE 100 recognizes the MBS session provided by the SFN, based on the SFN-related information. Alternatively, the UE 100 identifies the SDAP/PDCP/RLC/MAC entity that does not perform reestablishment/reset processing at the time of handover.

In Step S214, the gNB 200A determines handover of the UE 100.

In Step S215, the gNB 200A transmits a handover request message to the gNB 200B. The gNB 200B determines to accept the handover of the UE 100.

In Step S216, the gNB 200B transmits a handover request acknowledge message to the gNB 200A. The message includes an RRC Reconfiguration message (handover command). The RRC Reconfiguration message need not include AS configuration (bearer configuration or the like) for receiving the MBS session provided by the SFN. Specifically, because the UE 100 is already receiving the SFN and continuously uses the configuration, the UE 100 does not require the AS configuration for receiving the MBS session provided by the SFN. Note that the RRC Reconfiguration message may include the MBS session identifier, the bearer ID, or the like of the MBS session provided by the SFN.

In Step S217, the gNB 200A that has received the handover request acknowledge message transmits the RRC Reconfiguration message to the UE 100 (handover command).

In Step S218, the UE 100 continues reception operation of the bearer associated with the MBS session provided by the SFN. The UE 100 may reconfigure a unicast bearer and a multicast/broadcast bearer with which the SFN is not configured, in accordance with the RRC Reconfiguration message, for example.

In Step S219, the UE 100 performs the random access procedure with the target cell C2 (gNB 200B).

In Step S220, the UE 100 performs PTM reception from the target cell C2 (gNB 200B).

### Third Embodiment

A third embodiment will be described mainly regarding differences from the first and second embodiments described above.

Each of the following embodiments is an embodiment for performing handover in which PTM reception can be continued between cells in which the SFN is not configured. A case in which the SFN is not configured refers to a case in which each cell performs single cell transmission or a case in which handover is performed to an SFN of another frequency (for example, a case in which one SFN and another SFN are disconnected due to deployment).

In each of the following embodiments, it is assumed that the source cell C1 and the target cell C2 perform PTM transmission of the same MBS session. The two cells may perform different frequencies and/or different MTCH scheduling (including the MCS).

It is assumed that MBS data transmission timings of the source cell C1 and the target cell C2 are “roughly” synchronized. “Roughly” means that, regarding the same MBS packet (the PDCP data PDU having the same PDCP SN), transmission timings of the two cells are not significantly apart from each other. Note that the two cells need not necessarily transmit the MBS packet having the same PDCP SN at certain time. Thus, radio frames of the two cells need not synchronize.

It is assumed that the same sequence number (PDCP SN) is assigned to the same MBS packet (IP packet) in the two cells. Because one PDCP PDU is generated for each single IP packet, on the condition that the PDCP SNs of the first IP packets match in the two cells, correspondence between subsequent MBS packets and PDCP SNs match regardless of the cells.

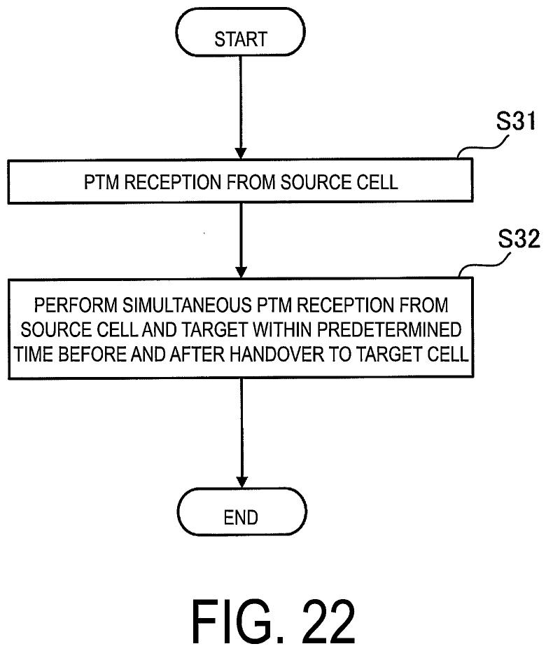

FIG. 22 is a diagram illustrating operation of the UE 100 according to the third embodiment.

In Step S31, the UE 100 in the RRC connected state in the source cell C1 receives an MBS session provided by the source cell C1 through PTM.

In Step S32, the UE 100 performs simultaneous reception of receiving both of the MBS session provided by the source cell C1 and the MBS session provided by the target cell C2 within a predetermined time before handover to the target cell C2 providing the MBS session through PTM and/or within a predetermined time after the handover.

Owing to such simultaneous reception (simultaneous PTM reception) from the two cells, the lossless handover can be implemented between the cells in which the SFN is not configured. Note that the UE 100 includes a plurality of reception devices.

In Step S32, the UE 100 may start simultaneous reception before the handover (before the handover execution). For example, the UE 100 that performs PTM reception from the cell C1 may start PTM reception from the cell C2 before receiving the handover command from the source cell C1.

In Step S32, after the handover (after the handover execution), the UE 100 may start PTM reception (MBS reception) from the target cell C2, and continue PTM reception from the source cell C1.

In Step S32, when a second sequence number of the MBS data (PDCP data PDU) first received from the target cell C2 is greater than a first sequence number of the MBS data (each PDCP data PDU) received from the source cell C1, the UE 100 may perform MBS reception from the source cell C1 until a gap between the first sequence number and the second sequence number is eliminated, that is, until the first sequence number reaches the second sequence number.

In Step S32, when the second sequence number of the MBS data (PDCP data PDU) first received from the target cell C2 is smaller than the first sequence number of the MBS data (each PDCP data PDU) received from the source cell C1, the UE 100 may determine that there is no gap between the first sequence number and the second sequence number, and stop MBS reception from the source cell C1.

When data loss occurs despite the fact that UE 100 performs simultaneous reception, the UE 100 may request the target cell C2 to retransmit the lost data.

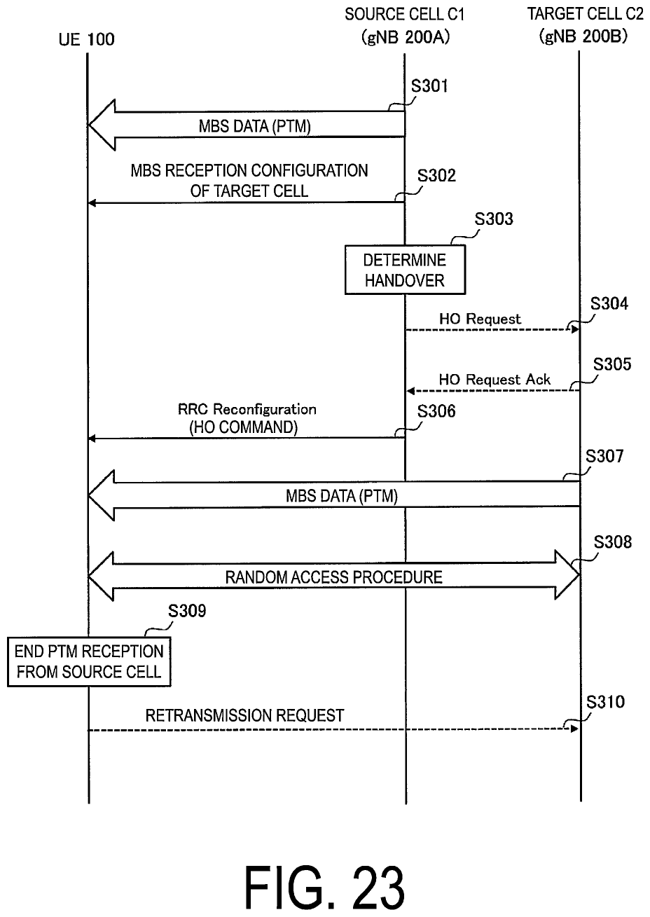

FIG. 23 is a diagram illustrating an example of operation of the mobile communication system 1 according to the third embodiment.

In Step S301, the UE 100 performs PTM reception in the source cell C1.

In Step S302, the gNB 200A provides the MBS reception configuration of the target cell C2 to the UE 100. The gNB 200A may transmit the MBS reception configuration of the target cell C2, using UE-dedicated signaling (for example, an RRC Reconfiguration message) or broadcast signaling (for example, an SIB or an MCCH). The gNB 200A may provide the MBS reception configuration of the target cell C2, using a handover command (RRC Reconfiguration message with sync) of Step S306.

In Step S303, the gNB 200A determines to perform handover of the UE 100.

In Step S304, the gNB 200A transmits a handover request message to the gNB 200B. The gNB 200B that has received the handover request message determines to accept the handover.

In Step S305, the gNB 200B transmits a handover request acknowledge message to the gNB 200A. The message includes an RRC Reconfiguration message (handover command) to be transmitted to be UE 100 via the gNB 200A.

In Step S306, the gNB 200A transmits a handover command to the UE 100. Note that the handover command may be a handover command for indicating (configuring) conditional handover. In a case of the conditional handover, at the time of configuring, triggering, or executing the conditional handover, the UE 100 may start PTM reception from the target cell C2 of Step S307.

In Step S307, the UE 100 starts PTM reception from the target cell C2 in accordance with the MBS reception configuration received from the source cell C1 in Step S302 (or Step S306). At this time point, the UE 100 has received data of the same MBS session from both of the source cell C1 and the target cell C2. Note that, when the UE 100 receives an overlapping packet (a packet that has already been received), the UE 100 may discard the packet (in the PDCP layer).

In Step S308, the UE 100 starts to access the target cell C2, and completes handover processing.

In Step S309, the UE 100 ends MBS reception from the source cell C1.

Here, the UE 100 may end MBS reception from the source cell C1 at the time point when the PDCP SN gap is eliminated between the source cell C1 and the target cell C2. Specifically, when the PDCP SN of the source cell C1 is later than the PDCP SN of the target cell C2, that is, when, for example, the source cell C1 is of SN #5 and the target cell C2 is of SN #10 regarding the MBS data currently received by the UE 100, the UE 100 receives the PDCP data PDUs of SN #10 and subsequent SNs from the target cell C2 and receives the PDCP data PDUs of SN #5 to SN #9 from the source cell C1. The SN gap is eliminated at the time point when the PDCP data PDUs of SN #5 to SN #9 are received from the source cell C1, and thus the UE 100 ends PTM reception from the source cell C1. As a result, the UE 100 can correctly receive the PDCP data PDUs of SN #5 and subsequent SNs.

Note that, when the PDCP SN of the source cell C1 is earlier than the PDCP SN of the target cell C2, that is, when, for example, the source cell C1 is of SN #10 and the target cell C2 is of SN #5 regarding the MBS data currently received by the UE 100, the UE 100 may consider that there is no SN gap and end PTM reception from the source cell C1. The UE 100 may discard the PDCP data PDUs of SN #5 to SN #10 received in an overlapping manner (because the PDCP data PDUs have already been received from the source cell C1). As a result, the UE 100 can correctly receive the PDCP data PDUs of SN #5 and subsequent SNs.

In Step S310, when data loss occurs regardless of the simultaneous reception (simultaneous PTM reception), for example, when the PDCP data PDU of SN #6 is lost due to deterioration of a radio state, the UE 100 may perform, to the target cell C2, a retransmission request of the PDCP data PDU of SN #6 to the target cell C2. The request may be notified on a PDCP Status Report (or a new PDCP Control PDU). Alternatively, the request may request configuration of the PTP leg. In this case, when there is no PTP leg, it can be assumed that the PTM-only MRB is used, and thus the PDCP Status Report cannot be used as a PTP leg configuration request. Thus, the PTP leg configuration request may be transmitted to the target cell C2, using RRC signaling (for example, an MBS Interest Indication (MII) message or a UE Assistance Information message).

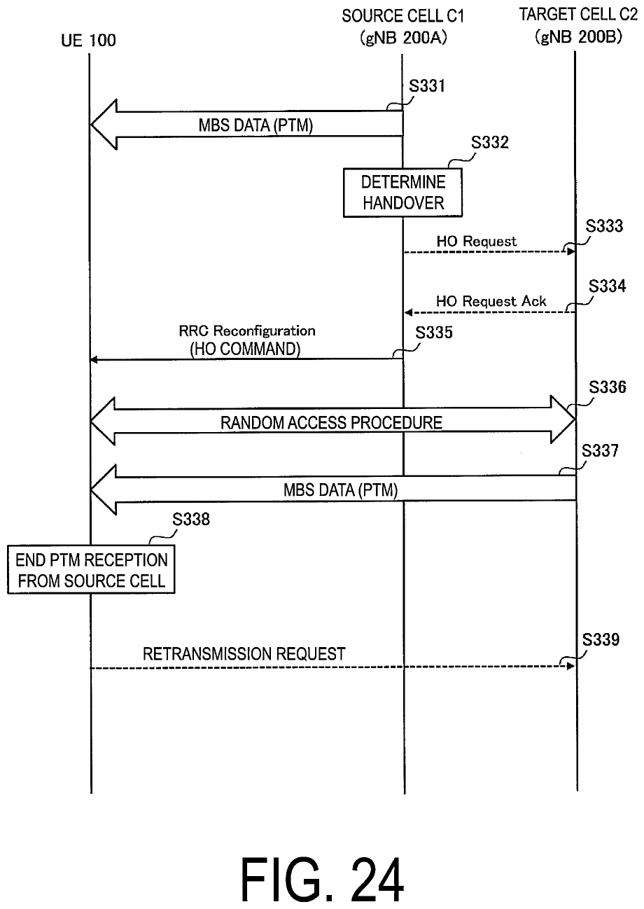

FIG. 24 is a diagram illustrating another example of operation of the mobile communication system 1 according to the third embodiment. In the present operation example, the UE 100 continues MBS data reception from the source cell C1 even after accessing the target cell C2, and stops the MBS data reception from the source cell C1 at the time point when the PDCP SN gap is eliminated.

In Step S331, the UE 100 performs PTM reception in the source cell C1.

In Step S332, the gNB 200A determines to perform handover of the UE 100.

In Step S333, the gNB 200A transmits a handover request message to the gNB 200B. The gNB 200B that has received the handover request message determines to accept the handover.

In Step S334, the gNB 200B transmits a handover request acknowledge message to the gNB 200A. The message includes an RRC Reconfiguration message (handover command) to be transmitted to be UE 100 via the gNB 200A.

In Step S335, the gNB 200A transmits a handover command to the UE 100. The gNB 200A may include, in the handover command, information for permitting MBS continuous reception from the source cell C1, for example, the MBS session identifier, the QFI, the bearer

ID, or the like for permitting MBS continuous reception. The handover command may include the MBS reception configuration of the target cell C2.

In Step S336, the UE 100 accesses the target cell C2 (random access procedure).

In Step S337, after the UE 100 completes the access, the UE 100 starts PTM reception from the target cell C2. Here, the UE 100 continues MBS reception from the source cell C1, and has received data of the same MBS session from both of the source cell C1 and the target cell C2. When the UE 100 receives an overlapping packet (a packet that has already been received), the UE 100 may discard the packet.

In Step S338, the UE 100 ends MBS reception from the source cell C1. The processing is the same as and/or similar to that of Step S309 described above.

In Step S339, when data loss occurs regardless of the simultaneous reception (simultaneous PTM reception), the UE 100 may perform a retransmission request to the target cell C2. The processing is the same as and/or similar to that of Step S310 described above.

### Fourth Embodiment

A fourth embodiment will be described mainly regarding differences from the first to third embodiments described above.

In the fourth embodiment, it is assumed that the target cell C2 (and the source cell C1) performs MBS delivery in the second delivery mode (Delivery Mode 2 (DM2)) described above. The fourth embodiment may be performed in combination with the third embodiment described above.

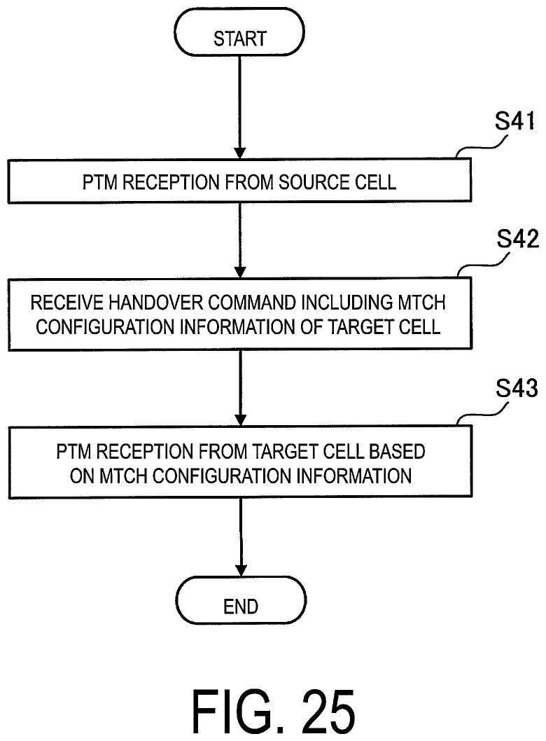

FIG. 25 is a diagram illustrating operation of the UE 100 according to the fourth embodiment.

In Step S41, the UE 100 in the RRC connected state in the source cell C1 receives an MBS session provided by the source cell C1 through PTM.

The UE 100 receives, from the source cell C1, a handover command for indicating handover to the target cell C2. The handover command includes the MTCH configuration information for receiving the MBS session provided by the target cell C2. Specifically, the handover command includes the MTCH configuration information of the MTCH that provides, in the target cell C2, the same MBS session as the MBS session being currently received by the UE 100 in the source cell C1, and does not include the MTCH configuration information of other MTCHs of the target cell C2.

In Step S43, after the handover (after the handover execution), the UE 100 receives the MBS session provided by the target cell C2, based on the MTCH configuration information received in Step S42.

In the fourth embodiment, the source cell C1 provides, to the UE 100, only a piece of MTCH configuration information corresponding to the MBS session received by the UE 100 in the source cell C1 out of a plurality of pieces of MTCH configuration information provided by the target cell C2 on the MCCH, using the handover command. Thus, the UE 100 can smoothly start reception of the MBS session in the target cell C2.

In the fourth embodiment, the gNB 200A (first base station) managing the source cell C1 may transmit, to the gNB 200B managing the target cell C2, a handover request message including MBS interest information indicating the MBS session the UE 100 is currently receiving or is interested in receiving. The gNB 200B that has received the handover request message may identify a piece of MTCH configuration information corresponding to the MBS session indicated by the MBS interest information, and transmit a response message (handover request acknowledge message) including the identified piece of MTCH configuration information to the gNB 200A. The gNB 200A that has received the response message may transmit a handover command including the piece of MTCH configuration information from the gNB 200B to the UE 100.

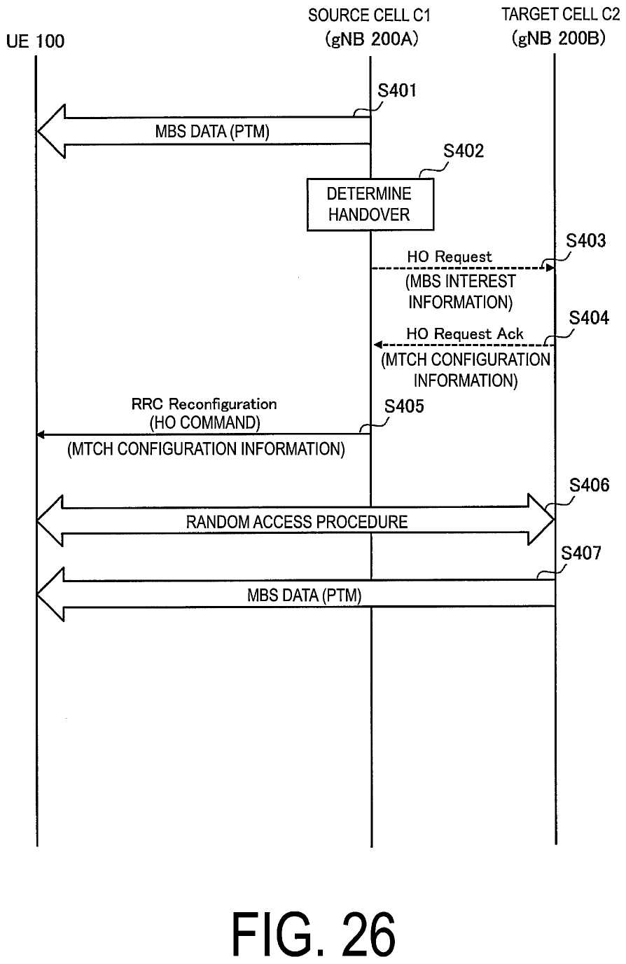

FIG. 26 is a diagram illustrating an example of operation of the mobile communication system 1 according to the fourth embodiment.

In Step S401, the UE 100 may perform PTM reception in the source cell C1. The gNB 200A recognizes information (MBS interest information) of the MBS session the UE 100 is currently receiving or is interested in receiving. For example, the gNB 200A may recognize the MBS session, based on an MII message transmitted from the UE 100 to the gNB 200A. The gNB 200A may recognize the MBS session, based on UE context information notified from the CN 20 to the gNB 200A. The gNB 200A stores the MBS interest information as a UE context.

In Step S402, the gNB 200A determines to perform handover of the UE 100.

In Step S403, the gNB 200A transmits a handover request message to the gNB 200B. The handover request message includes the MBS interest information of the UE 100. The gNB 200B that has received the handover request message determines to accept the handover.

Based on the MBS interest information of the UE 100, the gNB 200B recognizes the MBS session the UE 100 is currently receiving or is interested in receiving, and identifies a piece of MTCH configuration information (in particular, MTCH scheduling information) of the MTCH corresponding to the recognized MBS session. The gNB 200B includes the identified piece of MTCH configuration information in a handover request acknowledge message (specifically, a handover command/RRC Reconfiguration message). Here, the gNB 200B may include pieces of MTCH configuration information of a plurality of MTCHs in the handover command; however, the gNB 200B includes, in the handover command, only a piece of MTCH configuration information related to the MBS session in which the UE 100 is interested, instead of the whole details of the MCCHs in the target cell C2.

In Step S404, the gNB 200B transmits a handover request acknowledge message to the gNB 200A. The message includes an RRC Reconfiguration message (handover command) to be transmitted to be UE 100 via the gNB 200A.

In Step S405, the gNB 200A that has received the handover request acknowledge message extracts the handover command stored in the message, and transmits the handover command (RRC Reconfiguration message) to the UE 100.

In Step S406, the UE 100 applies the handover command (RRC Reconfiguration message) received in Step S405, and starts to access the target cell C2 (random access procedure).

In Step S407, the UE 100 completes the access, and starts reception of the MTCH of the target cell C2 from the MTCH scheduling information provided in the RRC Reconfiguration message received in Step S405. Thus, the UE 100 can continue reception of the MBS session without interrupting the service in the handover.

### Fifth Embodiment

A fifth embodiment will be described mainly regarding differences from the first to fourth embodiments described above.

Under the assumption that the source cell C1 and the target cell C2 provide the same MBS session, when the PDCP SN in the target cell C2 is later than the PDCP SN in the source cell C1, MBS data loss due to handover less likely occurs. Thus, in the fifth embodiment, each cell performs dual stream transmission of transmission in a PDCP SN roughly synchronized with another cell and transmission in a PDCP SN later than the PDCP SN.

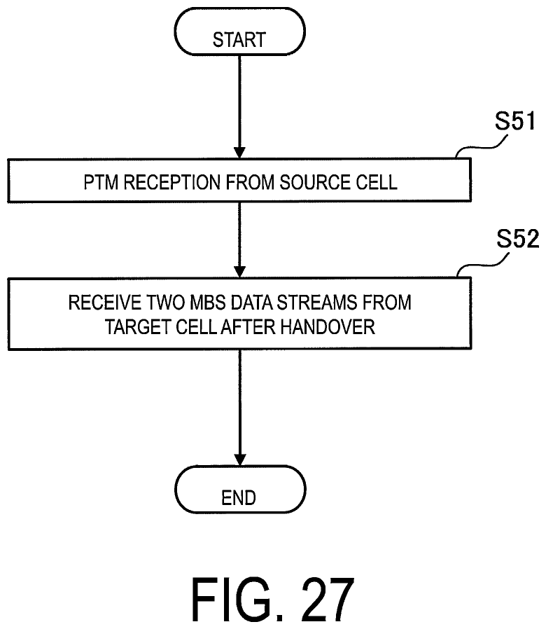

FIG. 27 is a diagram illustrating operation of the UE 100 according to the fifth embodiment.

In Step S51, the UE 100 in the RRC connected state in the source cell C1 receives an MBS session provided by the source cell C1 through PTM.

In Step S52, after handover to the target cell C2 providing the MBS session, the UE 100 receives two MBS data streams belonging to the MBS session from the target cell C2. The two MBS data streams have different sequence numbers (specifically, PDCP SNs) at the same time point. Note that, in the fifth embodiment, the UE 100 may be capable of receiving a plurality of data streams, and the number of reception devices may be one or more.

The two MBS data streams may have different modulation and coding schemes (MCSs). For example, the target cell C2 applies a first MCS to a transmission stream in a PDCP SN roughly synchronized with the source cell C1, and applies a second MCS to a transmission stream in a PDCP SN later than the PDCP SN. The second MCS may be an MCS having a higher data rate (i.e., lower error tolerance) than the first MCS.

The two MBS data streams may be configured as sub-MBS sessions or QoS flows included in one MBS session, and transmitted on different MTCHs. The two MBS data streams may be multiplexed using space division multiplexing (SDM), frequency division multiplexing (FDM), and/or time division multiplexing (TDM).

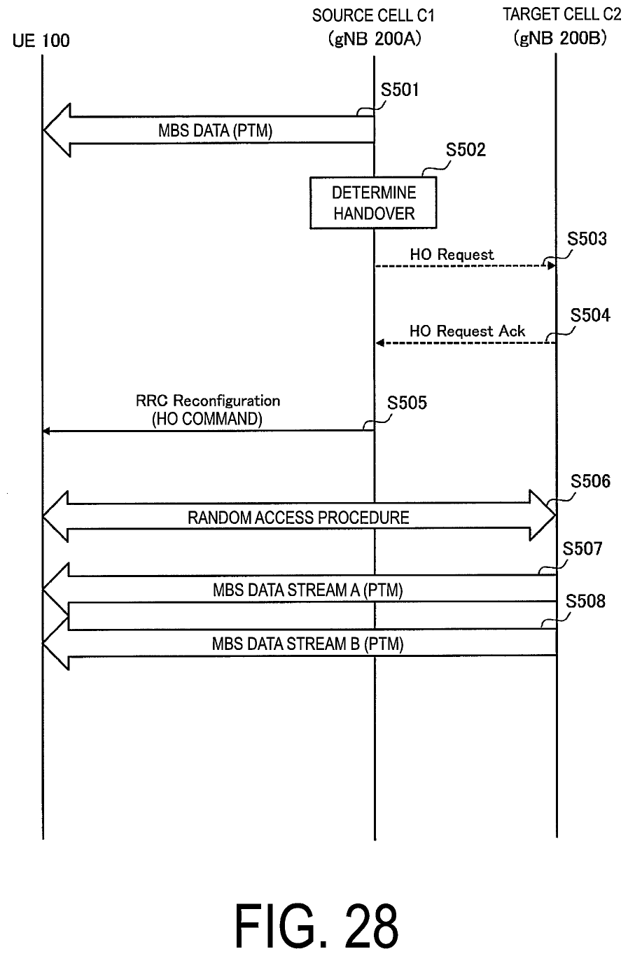

FIG. 28 is a diagram illustrating an example of operation of the mobile communication system 1 according to the fifth embodiment.

In Step S501, the UE 100 performs PTM reception in the source cell C1.

In Step S502, the gNB 200A determines to perform handover of the UE 100.

In Step S503, the gNB 200A transmits a handover request message to the gNB 200B. The gNB 200B that has received the handover request message determines to accept the handover.

In Step S504, the gNB 200B transmits a handover request acknowledge message to the gNB 200A. The message includes an RRC Reconfiguration message (handover command) to be transmitted to be UE 100 via the gNB 200A.

In Step S505, the gNB 200A that has received the handover request acknowledge message extracts the handover command stored in the message, and transmits the handover command (RRC Reconfiguration message) to the UE 100. The UE 100 that has received the handover command ends PTM reception from the source cell C1.

In Step S506, the UE 100 applies the handover command (RRC Reconfiguration message) received in Step S505, and starts to access the target cell C2 (random access procedure).

In Step S507 and Step S508, the gNB 200B (target cell C2) transmits two MBS data streams (two PTM streams) A and B regarding the same MBS session. The gNB 200B (target cell C2) may start to transmit the two MBS data streams A and B at this time point, or may transmit the two MBS data streams A and B in advance. In the two MBS data streams A and B, packets of different SNs are transmitted at a certain time point.

Here, the MBS session identifier of the MBS session provided by the source cell C1 is “TMGI-1”, the MBS session identifier of the MBS data stream A provided by the target cell C2 is “TMGI-1A”, and the MBS session identifier of the MBS data stream B provided by the target cell C2 is “TMGI-1B”. For example, although data of the same MBS session is transmitted with TMGI-1A and TMGI-1B, at a certain time point, later (older) data is transmitted with TMGI-1B. Correspondence between the SNs in respective PTM transmissions at this time point is as follows, for example.
Source cell C1: TMGI-1: SN #5
Target cell C2: TMGI-1A: SN #10
Target cell C2: TMGI-1B: SN #3

The UE 100 starts PTM reception of TMGI-1A and TMGI-1B in the target cell C2. In a case of the correspondence described above, the UE 100 has already received up to SN #5 from the source cell C1. For example, the UE 100 may receive SN #3 to SN #9 from TMGI-1B of the target cell C2, and discard SN #3 to SN #5 as they overlap. The UE 100 simultaneously receives SN #10 and subsequent SNs from TMGI-1A of the target cell C2. The UE 100 ends reception of TMGI-1B at the time point when the SN gap is eliminated.

As a variation of such an operation, different MCSs may be applied to two MBS data streams A and B. In the present variation, the UE 100 may be capable of receiving only one stream. For example, correspondence between the SN and the MCS in each PTM transmission at the time point of Step S507 and Step S508 is as follows.
Source cell C1: TMGI-1: SN #5
Target cell C2: TMGI-1A: SN #10: MCS 10 (low data rate)
Target cell C2: TMGI-1B: SN #3: MCS 16 (high data rate)

Note that the MCS applied to each stream may be defined in advance. The target cell

C2 may provide information as to which stream is a stream with a high data rate (stream for recovery) to the UE 100.

The UE 100 first starts PTM reception of TMGI-1B in the target cell C2. In a case of the correspondence described above, the UE 100 has already received up to SN #5 from the source cell C1. The UE 100 receives SN #3 to SN #9 (+α) from TMGI-1B of the target cell C2.

The UE 100 ends reception of TMGI1-B and starts reception of TMGI-1A at the time point when the SN gap is considered to be eliminated. Then, the UE 100 receives SN #9 (+α) and the like from TMGI-1A of the target cell C2.

Note that the gNB 200B may provide information of the SN gap and an MCS difference (that is, when the SN gap is to be eliminated) to the UE 100. For example, the gNB 200B may provide information to the UE 100, such as information that the gap is to be eliminated as a result of receiving in the stream of TMGI-1B ten times.

### Sixth Embodiment

A sixth embodiment will be described mainly regarding differences from the first to fifth embodiments described above.

The sixth embodiment is an embodiment in which information is shared between the gNB 200A and the gNB 200B under the assumption that the operation according to the first to fifth embodiments described above is performed.

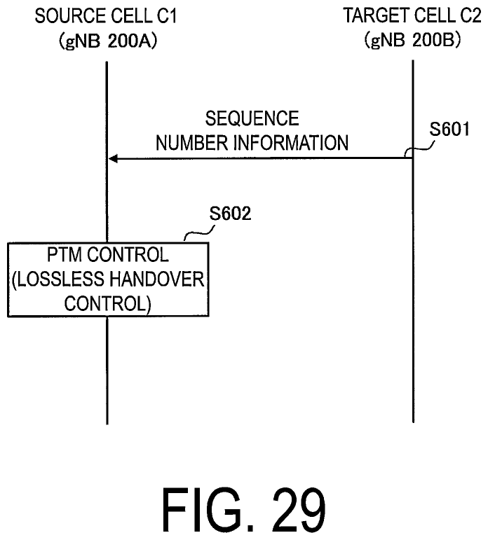

FIG. 29 is a diagram illustrating operation of the mobile communication system according to the sixth embodiment.

In Step S601, the gNB 200B providing an MBS session transmits, to the gNB 200A, sequence number information indicating a sequence number (PDCP SN) of the MBS data transmitted in the MBS session. Prior to Step S601, the gNB 200A may request the gNB 200B to provide information related to the transmitted SN of the MBS session currently provided.

The sequence number information transmitted from the gNB 200B to the gNB 200A may be included in an NG-RAN node Configuration Update message or a new Xn message, for example. The sequence number information may be provided for each cell (for each cell ID) managed by the gNB 200B. The sequence number information may be provided for each MBS session (for each MBS session identifier) provided by the gNB 200B. The sequence number information may include MBS session information currently provided by the gNB 200B and PDCP SN information of the currently transmitted data. The PDCP SN information may be a transmission PDCP SN at reference time (a previous transmission SN or the next transmission SN). Here, the reference time may be time determined using GPS, or may be a radio frame number (SFN or the like).

In Step S602, the gNB 200A performs PTM control as described above (MBS session provision control), based on the sequence number information from the gNB 200B.

For example, the gNB 200A may compare transmission SN information of the MBS session being provided by the gNB 200B and the transmission SN of the MBS session of the gNB 200A, recognize the SN gap (including which is earlier/later), and perform the following lossless handover control.
The gNB 200A notifies the UE 100 of information as to whether data recovery processing (simultaneous reception processing) is required after handover.
The gNB 200A provides the MTCH configuration information of the target cell C2 to the UE 100, and/or instructs the UE 100 to immediately start MTCH reception from the target cell C2.
The gNB 200A permits the UE 100 to continue MBS data reception from the source cell C1 even after handover.
The gNB 200A instructs the gNB 200B to perform dual stream transmission with different SNs and/or MCSs after handover, and/or instructs the UE 100 to perform dual stream reception with dual stream reception SNs and/or MCSs after handover.

Note that, in the sixth embodiment, transmission of the sequence number information from the gNB 200B to the gNB 200A may be performed only when the SN of the source cell C1 is later than the SN of the target cell C2. The gNB 200A need not perform the lossless handover control as described above when the SN of the source cell C1 is earlier than the SN of the target cell C2. Specifically, when the SN of the source cell C1 is earlier than the SN of the target cell C2, packets received from the target cell C2 overlap those of the source cell C1 but are not rendered “unreceived”, and thus continuity of the SN can be secured.

### OTHER EMBODIMENTS

The operation flows described above can be separately and independently implemented, and also be implemented in combination of two or more of the operation flows. For example, some of the steps in one operation flow may be applied to another operation flow. Some of the steps of one operation flow may be replaced with some of the steps of another operation flow. The order of steps in each operation flow described above may be changed as appropriate.

In the embodiments and examples described above, an example in which the base station is an NR base station (i.e., a gNB) is described; however, the base station may be an LTE base station (i.e., an eNB) or a 6G base station. The base station may be a relay node such as an Integrated Access and Backhaul (IAB) node. The base station may be a DU of the IAB node. The user equipment may be a Mobile Termination (MT) of the IAB node.

A program causing a computer to execute each of the processes performed by the UE 100 or the gNB 200 may be provided. The program may be recorded in a computer readable medium. Use of the computer readable medium enables the program to be installed on a computer. Here, the computer readable medium on which the program is recorded may be a non-transitory recording medium. The non-transitory recording medium is not particularly limited, and may be, for example, a recording medium such as a CD-ROM or a DVD-ROM. Circuits for executing processing performed by the UE 100 or the gNB 200 may be integrated, and at least a part of the UE 100 or the gNB 200 may be implemented as a semiconductor integrated circuit (chipset, system on a chip (SoC)).

The phrases “based on” and “depending on” used in the present disclosure do not mean “based only on” and “only depending on,” unless specifically stated otherwise. The phrase “based on” means both “based only on” and “based at least in part on”. Similarly, the phrase “depending on” means both “only depending on” and “at least partially depending on”. “Obtain” or “acquire” may mean to obtain information from stored information, may mean to obtain information from information received from another node, or may mean to obtain information by generating the information. The terms “include”, “comprise” and variations thereof do not mean “include only items stated” but instead mean “may include only items stated” or “may include not only the items stated but also other items”. The term “or” used in the present disclosure is not intended to be “exclusive or”. Further, any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Embodiments have been described above in detail with reference to the drawings, but specific configurations are not limited to those described above, and various design variation can be made without departing from the gist of the present disclosure.

### Supplementary Note

### 1. Introduction

A revised work item related to NR multicast and broadcast services (MBS) is approved in RAN #88. This has the objective to define mobility including dynamic PTM/PTP switch and service continuity as follows.

RAN basic functions of broadcast/multicast of the UE in the RRC connected state are defined. Support of dynamic change of broadcast/multicast service delivery between multicast (PTM) and unicast (PTP) provided with service continuity of a specific UE is defined. Support of basic mobility provided with service continuity is defined.

Regarding dynamic PTM/PTP switch, in RAN2, some agreements related to this topic have already been reached. RAN2 #111-e has the following agreements.

In a case of the UE, the gNB dynamically determines which is to be used to deliver multicast data among PTM and PTP (shared delivery).

A further study is required on a case in which a layer processes reliability (generally), in-order delivery/overlapping processing, and a further study is required on how the layer functions in switch between PTM and PTP.

In RAN2 #113-e, the following agreement has been reached regarding a discussion related to L2 reliability in architecture of dynamic PTM/PTP switch.

When both of PTM and PTP are RLC UM, there is no L2 ARQ, and configuration using switch between PTM and PTP with a fixed PDCP is supported (for example, in a case of a service usually configured in RLC UM for unicast).

In RAN2 #113bis-e, regarding architecture and signaling, a further agreement has been reached as follows.

### Agreement

It should be noted that the following agreement is based only on determination of architecture thus far. A discussion on reliability has not been completed. This, in other words, is a case other than RLC UM+RLC UM. A further study is required on switch between PTM and PTP of such another case.

Dynamic PTM/PTP switch is supported with a split MRB bearer (type) including a common (single) PDCP entity.

Basically, new UE-based signaling for supporting determination of gNB switch has not been introduced (for example, PDCP SR for high reliability is undetermined).

On an assumption of the split MRB configured with the PTM leg and the PTP leg (agreed during an online session), use of the PTP leg cannot be deactivated (that is, the UE need not constantly monitor the C-RNTI) after necessary split MRB configuration.

On an assumption of the split MRB configured with the PTM leg and the PTP leg (agreed during an online session), a further study is required on whether use of the PTM leg of the split MRB may be activated or deactivated and details thereof.

In terms of mobility, in RAN2, only the basic principles listed below are agreed. R2 has the objective to support lossless handover of MBS-MBS mobility of a service requiring this (details of scenarios are undetermined; at least PTP-PTP).

In order to support lossless handover of 5G MBS services, at least synchronization of DL PDCP SNs and continuity between the source cell and the target cell need not be secured in a network. A specific approach design for implementing this may relate to WG RAN3.

In a network, a source gNB may transfer data to a target gNB, and the target gNB delivers the transferred data. On the other hand, SN STATUS TRANSFER requires enhancement to cover the PDCP SN of MBS data. Next, the UE receives the MBS in the target cell by the target cell, in accordance with target configuration.

From the UE, a PDCP status report may also be supported.

In the supplementary note, the rest of problems of dynamic PTM/PTP switch and mobility provided with service continuity based on the agreed architecture, i.e., using the split MRB fixed to the PDCP, will be described.

### 2. DISCUSSION

### 3. Split MRB Configuration

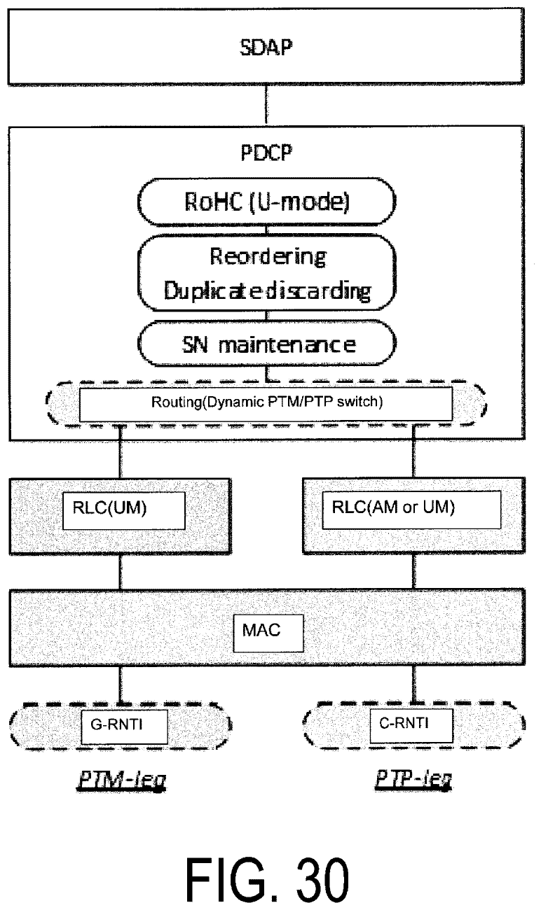

The architecture of switch of PTM/PTP fixed to the PDCP, i.e., the split MRB, can be interpreted as illustrated in FIG. 30, based on the current agreement.

In general, it can be considered that RRC reconfiguration is used to provide bearer configuration including two logical channels (the PTM leg and the PTP leg) as well as information for receiving a multicast session. RAN2 describes that “the split MRB configured with the PTM leg and the PTP leg (agreed during an online session) is assumed”; however, it is considered that provision of a configuration in which two logical channels are associated with one multicast radio bearer with RRC reconfiguration is already a common understanding as a preparation of dynamic PTM/PTP switch.

Observation 1: It is considered that provision of the configuration of associating two logical channels with one MRB with RRC reconfiguration is a common understanding, prior to dynamic PTM/PTP switch operation.

### 4. Dynamic PTM/PTP Switch Operation

### 5. Signaling

A further study is required on whether use of the split MRB and the PTM leg may be activated or deactivated and details thereof.

When the split MRB including the PTM leg/PTP leg is configured, the UE needs to monitor both of the G-RNTI of the PTM leg and the C-RNTI of the PTP leg. In LTE SC-PTM, “reception occasions of SC-PTM are independent of the unicast DRX scheme”, that is, DRXs are different. The G-RNTI is received by a plurality of UEs, whereas the C-RNTI is UE-specific, and two DRXs are significantly coordinate, and thus the concept may be the basic of the NR MBS. This means that, when the UE needs to constantly monitor the G-RNTI, the UE needs to frequently wake up, and this may lead to further power consumption. On the other hand, the UE in a connected state needs to monitor the C-RNTI, that is, the C-DRX, for unicast reception; however, this is not an additional burden on the UE.

Observation 2: The UE needs to wake up for a transmission occasion (that is, the G-RNTI) of the PTM leg as in an SC-MTCH occasion of LTE SC-PTM, in addition to a transmission occasion (that is, the C-RNTI) of the same PTP leg as the C-DRX.

At the time of reception of the MRB with PTM/PTM, that is, at the time of switch operation, the following four options are present.

Option 1: Activation/deactivation-based switch

The gNB instructs the UE to enable/disable the PTM leg, using DCI, a MAC CE, an RRC signal, or the like. This option enables more flexible handling of a case in which the MBS data is received via two legs as in the split bearer or PDCP packet redundancy, in addition to MBS data reception via either PTM or PTP. The UE can reduce power consumption from the deactivated PTM leg. In implementation of the NW, it should be noted that constant activation of two legs may be determined, and the purport of the following option 4 can be covered.

Option 2: Switch order/command-based switch

The gNB instructs the UE to switch between the PTM leg and the PTP leg, using DCI, a MAC CE, RRC signaling, or the like. This option is the same as and/or similar to option 1 described above, and is simple, in that power is saved through deactivation of the PTM leg. This option, however, is less flexible for operation regarding the split bearer including PDCP packet redundancy. It can be considered that this option concerns only switch between the PTM leg and the PTP leg, and both of them cannot be activated.

Option 3: RRC reconfiguration-based switch

The gNB reconfigures either PTM or PTP as the MRB for the UE with RRC reconfiguration. That is, the PTM leg and the PTP leg are not associated with one MRB. That is, it is similar to “bearer type change”, and is not consistent with the split MRB architecture. This option involves L3, and thus how “dynamically” switch between PTM and PTP can be performed remains questionable.

Option 4: Without signaling based on switch

The UE needs to constantly attempt reception from both of the PTM leg and the PTP leg when two legs are configured for the split MRB. With this option, maximum scheduling flexibility is secured from the perspective of the gNB, but the UE does not have an opportunity of power saving.

From the above, it can be said that option 1 is an option that is most appropriate in terms of flexibility of scheduling, power consumption of the UE, and consistency with the split MRB architecture. Option 4 may be regarded as a subset of option 1 when the PTM leg is constantly active. Regarding a signaling layer, the MAC CE may be simple because activation/deactivation is primarily related to the DRX operation. Therefore, RAN2 needs to agree that the PTM leg can be activated/deactivated via the MAC CE.

Proposal 1: For dynamic PTM/PTP switch, RAN2 needs to agree to introduce the MAC CE for activating/deactivating the PTM leg of the split MRB.

Regarding “bearer type change” different from dynamic switch, it is considered that the bearer type change has the following cases.
Case 1: PTM-only MRB←→PTP-only MRB
Case 2: Split MRB←→PTM-only MRB
Case 3: Split MRB←→PTP-only MRB

In a case of such bearer type change, it is simple to use RRC reconfiguration, that is, option 3.

Proposal 2: Regarding the PTM-only MRB, the PTP-only MRB, and the bearer type change between the split MRBs, RAN2 needs to agree on use of RRC reconfiguration.

### 6. Behavior of PDCP

### 7. Initial Value of State Variable

RAN2 agrees to support the RLC AM mode of the PTP leg of the split MRB in addition to the RLC UM mode. It is a common understanding that, because “RLC-AM does not support PTM (for MBS R17 WI)”, L2 reliability is dependent only upon dynamic PTM/PTP switch. Thus, how greatly packet loss at the time of start of MBS data reception and dynamic PTM/PTP switch can be reduced is worth being studied for the sake of service continuation.

As illustrated in FIG. 30, with reuse of an existing PDCP functional view, the PDCP SN is common to the PTM leg and the PTP leg. The PTM leg is used by a plurality of UEs, and thus the PDCP SN may not be UE-specific, which affects both of the PTM leg and the PTP leg. This means that, when the UE participates in a multicast session late, the initial value of each state variable cannot be constantly set to “0”, regardless of from which leg, the PTM leg or the PTP leg, the first received MBS data arrives. That is, the PDCP SN first received by the UE may be any value not assumed in the current unicast transmission. Because a state variable is configured to the initial value, PDCP reestablishment of a certain UE may affect all of the other UEs. This leads to discarding of unexpected operation in a reception window, that is an out-of-window PDCP PDU. A possibility of presence of the same problem also in handover scenarios is pointed out.

Observation 3: In a case of the UE with late participation in a multicast session and being configured with the split MRB, it is confirmed that the SN of the first received PDCP PDU is not the initial value (that is, “0”), regardless of the PTM leg or the PTP leg.

In order to solve the problem, the following options are proposed.

Option A: The gNB notifies the UE of the initial value of COUNT, or RX_NEXT and RX_DELIV.

This option is for simply changing the initial value related to the reception window based on information from the gNB so that the UE can receive first transmission of the MBS data in an existing mechanism. However, from the perspective of the PDCP layer, whether the UE can constantly correctly receive the first transmission intended by the gNB is questionable, due to delay in switch, deterioration of a radio state, outside of the RLC reconfiguration window, and the like. In this case, it is unclear how this option functions.

Option B: The gNB notifies the UE of an initial HFN, and the UE infers the initial HFN and the SN from the first received PDCP PDU.

The SN part is the option the same as and/or similar to the V2X mechanism of Rel-16, which is as follows. “The initial value of the SN part of RX_NEXT is (x+1) modulo (2^{[sl-PDCP-SN-Size]}), and x is the SN of the first received PDCP data PDU”, and “in NR sidelink communication for broadcast and groupcast, the initial value of the SN part of RX_DELIV is (x−0.5×2^{[sl-PDCP-SN-Size-1]}) modulo (2^{[sl-PDCP-SN-Size]}), where x is the SN of the first received PDCP Data PDU”.

Regarding the HFN part, in the Rel-16 V2X mechanism, the HFN is not used for the sake of security, and thus synchronization with a transmission device and a reception device is not necessary. That is, there is a description that “note: selection of the HFN of RX_NEXT is dependent upon implementation of the UE to make the initial value of RX_DELIV a positive value”. Regarding the NR MBS, “in RAN2, before a discussion of the aspect of security in RAN2, an answer is given that completion of research related to security of the MBS in SA3 is awaited”. Thus, in RAN2, the discussion of the HFN part needs to be postponed until completion of the research related to security in SA3.

From the above, a further discussion needs to be carried out based on option B. According to Rel-16 sidelink communication for broadcast and groupcast, in consideration of development of SA3 related to security of the NR MBS, RAN2 at least needs to agree that the UE configures the initial value of the state variable from the first received PDCP PDU of the MBS data.

Proposal 3: RAN2 needs to agree that the UE configures the initial value of the SN part of RX_NEXT and RX_DELIV from the first received MBS data, regardless of the PTM leg or the PTP leg. Whether the HFN part is notified from the gNB is dependent upon the progress of SA3, and a further study is required.

### 8. Simultaneous Reception and UE Assist Information

In particular, PTP (leg) is configured in RLC AM in a service requiring reliability, and as in observation 7 of the following section, lossless switch for the sake of service continuation is important, in a manner the same as and/or similar to lossless mobility. When proposal 1 is agreed on, the UE needs to support simultaneous reception from both of the PTM leg and the PTP leg. That is, two legs can be simultaneously activated in a manner the same as and/or similar to existing PDCP packet redundancy. This is for the following reason: because the PTM leg is received by a plurality of UEs, this may easily cause a non-optimal MCS for a specific UE. Thus, RAN2 needs to agree to adopt use of at least a certain period of simultaneous reception at the time of dynamic PTM/PTP switch.

Proposal 4: RAN2 needs to agree support of simultaneous reception of the UE from both of the PTM leg and the PTP leg for a certain period after dynamic PTM/PTP switch.

When proposal 3 and proposal 4 are agreed on, the gNB may not actually know which PDCP SN has been started to be correctly received by the UE via the PTM leg. In a case of switch from PTP to PTM, the gNB may not know when the PDCP PDU is to be transmitted using the PTP leg and when transmission of the PTP leg can be stopped. In order to solve the problem, it is proposed that the UE notifies the gNB of success in PTM reception, and performs transmission via the PTP leg. Note that whether the UE needs to also include PDCP SN information in the same message is unclear.

Observation 4: In a case of switch from PTP to PTM, the gNB may not know from which PDCP PDU the transmission of the PTP leg needs to be maintained, or from which PDCP PDU the UE correctly starts reception using the PTM leg.

In the same and/or similar manner, in a case of switch from PTM to PTP, the gNB may not know which PDCP SN the UE has correctly received via the PTM leg (in particular, when the radio state of the UE is poor). This means that the gNB may not know which PDCP PDU needs to be used at the time of start of the PTP leg.

Observation 5: In a case of switch from PTM to PTP, the gNB may not know from which PDCP PDU the transmission of the PTP leg needs to be started or which PDCP PDU the UE has correctly received via the PTM leg.

Thus, the following is studied: the UE notifies the gNB of SN information via the PTP leg at the time of dynamic PTM/PTP switch. When the UE reports the SN information at the time of dynamic switch between PTM and PTP, it is simple to reuse a PDCP control PDU, that is, the PDCP status report including FMC (first PDCP SDU is not found) and optionally a bitmap (indicating whether the following PDCP SDU is not found or correctly received). On the other hand, another option is that the UE reports the SN in which the UE has succeeded in first/last PDCP PDU reception via the PTM leg. Thus, a further discussion is required on details to be reported by the UE at the time of dynamic switch between PTM and PTP.

In either of the above cases (i.e., a case of switch from PTP to PTM and a case of switch from PTM to PTP), the PDCP control PDU including the PDCP SN information for the sake of service continuation needs to be triggered at the time of dynamic switch (for example, activation/deactivation of the MAC CE).

Proposal 5: RAN2 needs to study whether the UE needs to transmit the PDCP control PDU including the PDCP SN information at the time of dynamic switch for the sake of service continuation. A further study is required on whether PDCP information report can be reused.

Another point to be studied is whether lossless bearer type change the same as and/or similar to the lossless dynamic switch as in proposal 5 is required. It is considered that the bearer type change including PTP (leg) with RLC AM requires reliability the same as and/or similar to that of the dynamic switch from the perspective of service continuity and lossless mobility, as in observation 8 of the following section. Thus, RAN2 needs to study whether lossless bearer type change needs to be supported. When this is supported, the PDCP control PDU needs to be reused as the UE assist information in a manner the same as and/or similar to proposal 5.

Proposal 6: RAN2 needs to discuss whether the same solution as that for the lossless bearer type change with RRC reconfiguration, that is, the lossless dynamic switch using the PDCP control PDU as in proposal 5, can be applied.

### 9. Mobility Operation

RAN2 aims to support “a service that requires lossless handover of MBS-MBS mobility in R2 (although detailed scenarios are undetermined; at least PTP-PTP)”, and agrees that “the UE may also support the PDCP status report”. These agreements mean a mechanism significantly similar to existing handover for unicast, when the MRB is configured with PTP only.

Viewpoint 6: Also in the MRB configured with PTP only, an existing handover mechanism for unicast can be used and lossless handover can be supported.

In view of this, a study needs to be carried out on a case of handover including PTM (leg), that is, the MRB configured with PTM only and the split MRB including the PTP leg and the PTM leg.

The split MRB can be regarded as the PTP-only MRB when the PTM leg is deactivated. Thus, the lossless handover can be easily supported based on existing unicast handover. In view of this, a basic procedure of the split MRB is considered as follows.
Step 1: The PTM leg of the split MRB is deactivated in the source cell due to lossless dynamic switch.
Step 2: The UE executes lossless handover as in PTP-PTP handover (or as in unicast handover).
Step 3: The PTM leg of the split MRB is activated in the target cell as necessary due to lossless dynamic switch.

In the procedure, the lossless dynamic switch described in proposal 5 plays an important role.

Observation 7: The lossless dynamic PTM/PTP switch is crucial for the lossless handover of the split MRB.

Regarding the PTM-only MRB, a significantly similar procedure as below can be applied.
Step 1: The PTM-only MRB is reconfigured to the PTP-only MRB (or the split MRB) in the source cell due to lossless bearer type change.
Step 2: The UE executes lossless handover as in PTP-PTP handover (or as in unicast handover).
Step 3: The PTP-only MRB (or the split MRB) is reconfigured to the PTM-only MRB in the target cell as necessary due to lossless bearer type change.

In this case, the lossless bearer type change described in proposal 6 is also important for the lossless handover.

Observation 8: The lossless bearer type change is crucial for the lossless handover of the split MRB.

From the above, the points of the basic procedures of the lossless handover are that the PTM leg is deactivated or the PTM-only MRB is reconfigured (i.e., step 1) and execution of handover is the same as existing unicast handover and has no enhancement.

Proposal 7: RAN2 needs to agree that basic lossless handover of the MRB needs to constantly include PTP (leg), that is, the PTM leg of the split MRB needs to be deactivated before handover execution, or the PTM-only MRB needs to be reconfigured to the PTP-only MRB (or the split MRB).

Proposal 8: RAN2 needs to agree that execution of the handover of the MBS is the same as that of unicast, that is, enhancement for basic lossless handover is not necessary.

That is, the UE that receives the MBS via PTM (leg) executes lossless handover.

Signaling overhead and complexity in the basic handover procedure described above can be reduced. That is, step 1 and step 3 can be omitted. It is considered that such direct PTM-PTM lossless handover is expected to be used for the split MRB including the PTP leg configured with RLC AM in particular, that is, a service requiring higher reliability. However, the midpoint of Rel-17 is already past, and WID only describes “support of basic mobility provided with service continuity is defined”. Thus, advanced lossless handover needs to be postponed until future releases.

Observation 9: Although it is considered that advanced lossless handover of the UE that receives an MBS service via PTM (leg), that is, “direct PTM-PTM handover”, is effective for a specific service, this needs to be postponed until future releases in consideration of the remaining time of the Rel-17 time frame.

### REFERENCE SIGNS

1: Mobile communication system
10: RAN
20: CN
100: UE
110: Receiver
120: Transmitter
130: Controller
200: gNB
210: Transmitter
220: Receiver
230: Controller
240: Backhaul communicator

1. A communication method used in a mobile communication system for supporting a multicast and broadcast service (MBS), the communication method comprising:
receiving, by a user equipment in a radio resource control (RRC) connected state in a first cell, an MBS session provided by the first cell through Point-to-Multipoint (PTM);
receiving, by the user equipment from the first cell, an RRC Reconfiguration message indicating handover to a second cell; and
receiving, by the user equipment, the MBS session provided by the second cell after the handover, wherein
the RRC Reconfiguration message comprises MBS reception configuration for receiving the MBS session provided by the second cell.

2. The communication method according to claim 1, wherein
the MBS session is a multicast session.

3. The communication method according to claim 1, further comprising transmitting, by a first base station managing the first cell to a second base station managing the second cell, a handover request message comprising information indicating an MBS session the user equipment is currently receiving or is interested in receiving.

4. The communication method according to claim 2, further comprising:
transmitting, by the second base station having received the handover request message, a response message comprising the MBS reception configuration to the first base station; and
transmitting, by the first base station having received the response message, the RRC Reconfiguration message comprising the MBS reception configuration information from the second base station, to the user equipment.

5. The communication method according to claim 1, further comprising:
configuring, by a base station managing the first cell, a multicast radio bearer (MRB) comprising a Point-to-Multipoint (PTM) communication path for the user equipment in the RRC connected state;
switching, by the base station, from the PTM communication path to a Point-to-Point (PTP) communication path in response to determining handover of the user equipment from the first cell to the second cell; and
executing, by the base station, the handover after the switching to the PTP communication path.

6. The communication method according to claim 1, further comprising:
synchronizing, between the first cell and the second cell, a Packet Data Convergence Protocol (PDCP) variable for the MBS session.

7. The communication method according to claim 1, further comprising:
transmitting, by the user equipment, a Packet Data Convergence Protocol (PDCP) status report for requesting a retransmission of data lost in the handover, to a network.

8. The communication method according to claim 1, further comprising:
remaining, by the user equipment, a Packet Data Convergence Protocol (PDCP) entity used for MBS reception to continue MBS reception, in the handover.

9. A user equipment used in a mobile communication system for supporting a multicast and broadcast service (MBS), the user equipment comprising:
a receiver configured to:
receive an MBS session provided by a first cell through Point-to-Multipoint (PTM) when the user equipment is in a radio resource control (RRC) connected state in the first cell;
receive, from the first cell, an RRC Reconfiguration message indicating handover to a second cell; and
receiving the MBS session provided by the second cell after the handover, wherein
the RRC Reconfiguration message comprises MBS reception configuration for receiving the MBS session provided by the second cell.

10. A network node used in a mobile communication system for supporting a multicast and broadcast service (MBS), the network node comprising:
a transmitter configured to:
transmit an MBS session provided by a first cell through Point-to-Multipoint (PTM) to a user equipment being in a radio resource control (RRC) connected state in the first cell; and
transmit, to the user equipment, an RRC Reconfiguration message indicating handover to a second cell, wherein
the RRC Reconfiguration message comprises MBS reception configuration for receiving the MBS session provided by the second cell.

11. A mobile communication system comprising:
the user equipment according to claim 9.

12. A chipset for a user equipment used in a mobile communication system for supporting a multicast and broadcast service (MBS), the chipset comprising:
a circuitry configured to:
receive an MBS session provided by a first cell through Point-to-Multipoint (PTM) when the user equipment is in a radio resource control (RRC) connected state in the first cell;
receive, from the first cell, an RRC Reconfiguration message indicating handover to a second cell; and
receiving the MBS session provided by the second cell after the handover, wherein
the RRC Reconfiguration message comprises MBS reception configuration for receiving the MBS session provided by the second cell.

13. A non-transitory computer readable medium storing a program that, when the program is executed by a user equipment used in a mobile communication system for supporting a multicast and broadcast service (MBS), cause the user equipment to:
receive an MBS session provided by a first cell through Point-to-Multipoint (PTM) when the user equipment is in a radio resource control (RRC) connected state in the first cell;
receive, from the first cell, an RRC Reconfiguration message indicating handover to a second cell; and
receiving the MBS session provided by the second cell after the handover, wherein
the RRC Reconfiguration message comprises MBS reception configuration for receiving the MBS session provided by the second cell.
